(19) United States
(12) Patent Application Publication
(10) Pub. No.: US 2019/0340654 A1
(43) Pub. Date: Nov. 7, 2019

(54) SYSTEM AND METHOD FOR IMPROVED TARGETING AND MOBILIZATION OF A VOTING POPULATION

(71) Applicant: Project Applecart LLC, Philadelphia, PA (US)

(72) Inventors: Sacha Ian Samotin, Naples, FL (US); Matthew Harris Kalmans, Weston, CT (US); Anthony Liveris, New York, NY (US); Scott Riley, Henderson, NV (US)

(21) Appl. No.: 16/419,716

(22) Filed: May 22, 2019

Related U.S. Application Data
(63) Continuation of application No. 14/555,961, filed on Nov. 28, 2014, now abandoned.
(60) Provisional application No. 61/909,745, filed on Nov. 27, 2013.

(51) Int. Cl. G06Q 30/02

(52) U.S. Cl. CPC G06Q 30/0269; G06Q 30/0276

(57) ABSTRACT

Systems and methods are described which focus on targeting and mobilizing specific populations of voters who are present in every voting district, including infrequent voting moderate voters in gerrymandered highly partisan districts. Based on population segmentation modeling and data analysis, desired voters are targeted. An individualized message is developed for each targeted voter, the message presenting the voting records of that voter's (i) close friends, (ii) colleagues, (iii) family members, and (iv) other social influencers in relation to the voter's own record. The individualized message can be delivered to each targeted individual via a variety of individually addressable communication means, including but not limited to direct mail, e-mail, and digital outreach including banner, display, mobile, online application, and social media on-line advertising. Such individualized messages can successfully mobilize large numbers of the target voters. Methods of the present invention can be especially effective in primary elections, but can also be adapted for use in elections of all scales and types, and to a variety of other political and private sector applications.

### CROSS REFERENCE TO RELATED APPLICATIONS

The present application claims the benefit of U.S. Provisional Patent Application No. 61/909,745, filed Nov. 27, 2013, entitled “SYSTEM AND METHOD FOR IMPROVED TARGETING AND MOBILIZATION OF A VOTING POPULATION” which is hereby incorporated herein by reference in its entirety.

### TECHNICAL FIELD

The present invention is directed to data mining, analysis, and analytics as can be leveraged to support campaign or election management. In particular, systems and methods are disclosed for improved targeting and mobilization of a voting population using various data mining and analysis techniques, noting that the underlying technological innovation has applications to a plethora of campaign management functions, including but not limited to voter registration, fundraising, targeting, and general analytics, as well as to private sector applications ranging from product marketing to lobbying and government relations.

### BACKGROUND OF THE INVENTION

Modern political campaigns at all levels—federal, state, city, county and local—use a variety of tools to develop political messages that are intended to resonate with voters, influence voters in general, and influence voters' views on particular issues. These tools can include, for example, polls, phone solicitations, newspaper advertising, direct mail, radio and television advertising, online organizational tools, Internet-based advertising, and various other forms of digital content, among others.

Much of the money spent on the various forms of political advertising, often as much as 20-30%, is pocketed by campaign consultants. This inflates campaign expenditures with no material impact on election outcomes. While many of these campaign techniques are clearly proven to achieve varying degrees of effectiveness in persuading a registered voter that is already likely to vote to support one candidate over another, the other method by which campaigns aim to win elections is by altering the contour of the likely voting electorate by mobilizing infrequent voting populations that are likely to support their preferred candidate. Studies have shown that the aforementioned conventional forms of political advertising have a negligible, and in some cases even detrimental, effect on encouraging infrequent voting populations to show up at the polls on Election Day. One of the largest and most reputable bodies of research to document this reality is the work of political scientists Donald Green and Alan Gerber, as detailed in the various studies and other information provided on the Get Out the Vote website, at http://gotv.research.yale.edu. The challenge of mobilizing infrequent voting populations and finding effective ways to communicate with the likely voting electorate is one that afflicts candidates for office, parties, and ballot initiative efforts at every scale from the municipal level to the presidential, where deploying an effective solution to this challenge can be and often is the difference between success and failure. That said, discovering and implementing a solution to this issue can have a disproportionate effect on the lowest turnout races, primary elections, where every additional supportive vote goes farther than in higher turnout general elections.

As mentioned above, a fact of political life, which is particularly salient in primary elections, is extraordinarily low voter turnout. While most presidential elections see voter turnout that hovers around 60%, the average congressional primary election sees a mere 11.5% turnout, as shown in FIG. 1.

It is most often the case that those voters who dominate these low-turnout primaries by virtue of their likelihood to vote are the aforementioned hyper-partisan single-issue voters who are completely unrepresentative of the voting district at large. For example, as can be seen in FIG. 2, in the 2012 presidential general election, a majority of Texas voters self-identified as moderate, somewhat liberal, or very liberal. However, the congressional primary electorate self-identified as 55% very conservative.

Thus, when there are (i) very partisan congressional districts, combined with (ii) very low voter turnout, the fact is that the most politically active voters are voting in the primary elections. These voters are more often than not strongly affiliated with a particular political view—usually very liberal or very conservative—and they tend to vote for candidates who share their strongly held views. This, in turn, often results in the candidates who win primaries being aligned with (and in some cases, owing their political successes to) the more extreme primary voters and their strongly held views. However, these strongly held views may not be (and generally are not) shared by the larger pool of voters who vote in the general election—or even by those who are eligible to vote but do not vote.

In many people's view, this results in elected officials being sent to Washington as Congressmen who (i) reflect a minority of views in their district, and who (ii) also have no reason to compromise on their views in light of the strongly partisan component of their district. For example, Florida Congressman Alan Grayson (D), proclaimed at the height of the health care reform debate that: “If you get sick, America, the Republican health care plan is this: Die quickly. That's right. The Republicans want you to die quickly if you get sick.” He is emblematic of this phenomenon, as is Minnesota Congresswoman Michele Bachman (R), who asserted that “Carbon dioxide is portrayed as harmful. But there isn't even one study that can produced that shows that carbon dioxide is a harmful gas.”

To the extent that “gridlock” exists in politics when elected officials refuse to compromise on issues because their constituents do not want them to on a given issue, this cycle of hyper-partisanship may be the most significant proximate cause. In short, elected officials have no incentive to compromise and work across party lines to find solutions when they hail from a low turnout highly partisan or highly ideological district. Quite the contrary: keeping their job depends upon the support of the most hyper-partisan, ideologically extreme voters in their respective districts. Thus, the “gridlock” is not really due to Washington at all; rather, its cause lies in the highly partisan nature of certain congressional districts and their low-turnout, highly ideological, primary voters.

One way to address this problem is to pass legislation and ballot initiatives that strive to revise the design of congressional districts—i.e., to try and undo some of the “gerrymandering” that goes into the configuration of districts every ten years following the census—and alter the electoral process. Proposed reforms along these lines include independent redistricting commissions designed to depoliticize the process of drawing congressional districts, and electoral reforms such as the top-two primary system that is currently employed in California, in which candidates of all parties run in a primary and the top two-candidates advance to a general election runoff. These initiatives, however, are (i) slow to bear fruit, and (ii) fraught with numerous political obstacles. This suggests that neither solution will be seen in any meaningful form for quite some time, if ever.

Another approach is to impact how voters are targeted and ultimately mobilized to vote in elections, especially in primary elections where, as described above, a relatively small number of voters can have a disproportionate impact in deciding the winner. Ultimately, if additional voters were to be mobilized in low-turnout elections, especially primary elections, and those voters reflected a broader spectrum of political views than the hyper-partisan, highly ideological voters who typically dominate such elections, then candidates with broader views, more aligned with the voting constituency as a whole, may have a serious chance to win primaries, and as a result, general elections. Such more moderate candidates may be significantly better able to resolve political disputes once in office and thereby start to ameliorate some of the partisan fueled gridlock that currently exists.

What is thus needed in the art are systems and methods to identify and mobilize voters of various types that can have a real impact on low turnout elections. What is further needed are novel systems and methods to communicate with such voters so as to increase the likelihood that they will vote in such elections. At a macroscopic level, if deployed strategically, these systems will make substantial progress toward electing more moderate candidates to public office who are more likely to be representative of the electorate, to compromise, and to reduce paralyzing legislative gridlock. Simultaneously, if used by campaign operatives in the context of an individual race at any scale, whether primary or general election, the infrequent voting populations that are mobilized can often make the difference between victory and defeat in an individual race.

### SUMMARY OF THE INVENTION

Systems and methods are described for focusing on the targeting and mobilization of the moderate voters who are present in every voting district, including gerrymandered highly partisan districts, to help elect more moderate candidates to public office that are more representative of the electorate and are most likely to help reduce legislative gridlock. Additionally, the systems and methods described may be used by individual campaigns and independent expenditure groups to mobilize any given targeted voting population—whether moderate or not—to support a preferred candidate. Aspects of the core systems may be employed by a wide variety of political and private sector organizations to support a variety of functions ranging from product marketing to fundraising, voter persuasion, and voter registration.

Based on population segmentation modeling and data analysis, commonly referred to the political world as “microtargeting,” it can be determined which voters should be targeted for mobilization in order to support the user's motivations, whether supporting an individual candidate or mobilizing a particular segment of the electorate—for example, pro-gun control voters, or alternatively ideologically moderate voters. In exemplary embodiments of the present invention, an individualized message can be developed for each such targeted voter, the message presenting the voting records of that voter's (i) close friends, (ii) colleagues, (iii) family members, and (iv) other social influencers in relation to the voter's own record, as a way to exert, what is formally referred to as, “social pressure” on a targeted voter. Subsequently, the individualized message can be delivered to each targeted individual via a variety of individually addressable communication means, including, for example, direct mail, e-mail, and digital outreach including banner, display, mobile, and social media on-line advertising. Such an individualized message, in concert with accurate targeting and full-spectrum message delivery, can successfully mobilize large numbers of targeted voters. Methods of the present invention can be especially effective in primary elections, but can also be adapted for use in elections of all types and of various scales. Additionally, methods of the present invention may be adapted for mobilizing targeted individuals to take additional actions in a political context, such as donating, registering to vote, and supporting a specific candidate, and in a private sector context, such as purchasing a product or taking action to advocate for a specific targeted policy issue. The only difference between these additional methods and the one most prominently described here (infrequent voter mobilization) are the questions of who is targeted and what additional data is overlaid on the construction of the “social graph” used in the individual message. By overlaying campaign donation data, one embodiment of the invention would allow the individual message to be tailored to the targeted voter's history of and potential for political donation to a specific candidate along a specified ideological line. By overlaying issue and interest data, one embodiment of the invention would allow the individual message to be tailored to persuading the targeted voter to assess or reassess a political or ideological position. By laying eligible but currently unregistered voters into the social graph, one embodiment of the invention would allow the individual message to be tailored to convince that eligible registrant to actually take the action of registering. The fundamental approaches, technologies, and invention do not have to be substantially altered to achieve any one of these goals and any one of a whole host of other political, issue-based advocacy, non-profit, and consumer marketing paradigms.

### BRIEF DESCRIPTION OF THE DRAWINGS

FIG. 1 depicts the profound difference in voter turnout between presidential general elections and congressional primaries;

FIG. 2 depicts turnout amongst voters in Texas by ideology, in both presidential general, and congressional, primary elections;

FIG. 3 illustrates a first phase of an exemplary method wherein a voter file is obtained according to an exemplary embodiment of the present invention;

FIG. 4 illustrates collection, aggregation, analysis, and statistical modeling of data on targeted individuals to generate a microtargeting model to guide mobilization efforts according to an exemplary embodiment of the present invention;

FIG. 5 illustrates the identification of mobilization targets and collection of social data for mobilization targets according to an exemplary embodiment of the present invention;

FIG. 6 illustrates the process of collecting and appending social graph data to the voter file of FIG. 5 for treatment production;

FIG. 7 illustrates basic and enhanced mobilization treatments as applied to a voter file according to an exemplary embodiment of the present invention;

FIG. 8 illustrates actual delivery of messages to the voters targeted for mobilization according to an exemplary embodiment of the present invention;

FIGS. 9 through 14 illustrate an exemplary method for collecting social connection data from social media to input into the social graph, in this example, Facebook (though a similar process to gather the publicly available data of social network and integrate into the social graph);

FIGS. 15 through 29 illustrate exemplary specific instructions for operating the social connection data collection software according to an exemplary embodiment of the present invention;

FIGS. 30A, 30B and 30C collectively illustrates an exemplary representation of a social graph data developed for a specific voter according to an exemplary embodiment of the present invention

FIG. 31 illustrates exemplary direct mail delivery of the individualized messaging to a voter according to an exemplary embodiment of the present invent ion;

FIGS. 32A and 32B illustrate exemplary online ad contact delivery of the individualized messaging to a voter according to an exemplary embodiment of the present invention; and

FIG. 33 illustrates exemplary customized online interface delivery of the individualized messaging to a voter according to an exemplary embodiment of the present invention.

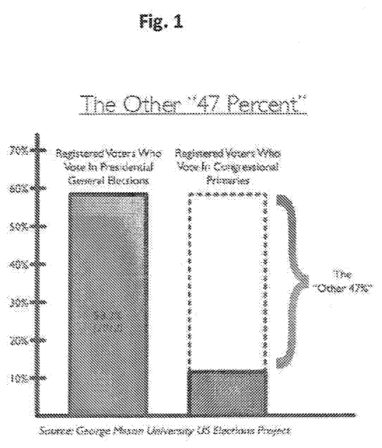

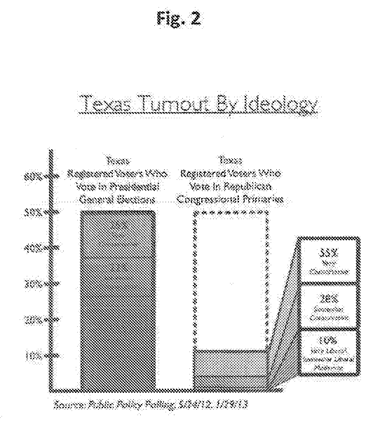

### DETAILED DESCRIPTION OF THE INVENTION

Systems and methods are described which use micro-targeting and data mining techniques to (i) classify voters by their ideology and or propensity to support a specific candidate or policy, and (ii) construct individualized political messaging most likely to impact targeted voters to turnout and cast their ballot or to perform specific desired actions or activities. The described systems and methods are especially effective in connection with elections of all scales, types and natures, but may also be applied to a host of other political applications from fundraising and voter persuasion to private sector lobbying and product marketing applications. In what follows, in describing various exemplary embodiments of the present invention, a trade name of “Applecart” or “Project Applecart” may often be used. This refers to the ability to “upset the applecart” and make significant change to the outcome of an election by using various exemplary embodiments of the present invention.

General Overview Traditional methods of voter contact are often ineffective at mobilizing the infrequent voting populations that may provide decisive victories in crucial elections. Applecart is thus geared specifically toward mobilizing infrequent voters with scientific rigor, cost efficacy, and at the largest scale imaginable.

Applecart can be targeted as selectively as door-to-door canvassing, with greater effectiveness, and in places where canvassing is impossible or financially impractical: from urban multi-family housing units and suburban subdivisions where canvassers cannot legally go, to rural areas where canvassing would waste precious resources. Each election cycle, SuperPACs and other expenditure groups oversaturate districts with millions of dollars spent on expensive TV ads that while effective for persuasion, frequently fail to mobilize voters. Additionally, because of pricing regulations favoring hard money expenditures from candidate and party committees, SuperPACs waste nearly 30% of their television budgets by paying commercial advertising rates.

By using Applecart the best possible use of soft money may be implemented on a data-driven, scientific solution that is custom-built to mobilize large populations of the infrequent voters that inevitably decide the outcome of competitive elections. It is noted that Applecart has produced the largest recorded voter turnout increase in U.S. history on behalf of some of the most prominent political spenders in the country, and offers the capability to provide that same result on behalf of any candidate or issue.

The Core of Project Applecart: An Innovative and Proven Tactic

Applecart's capability to mobilize large numbers of targeted, infrequent voters is based on a strategy that has been proven and well documented in a wide body of scientific research and its application in an actual electoral setting. In a series of large-scale experiments conducted in real elections to high degrees of statistical significance, then-Yale University scientists Donald Green, Alan Gerber, and Christopher Larimer engineered what was the largest recorded voter turnout increase in modern American history with a flight of simple letters to the registered voters in a state.

The letters began by notifying voters that their voting records are a matter of public record and provided voters with their voting record and those of their neighbors. The scientists wrote that they would send updated records to each voter and their neighbors after the upcoming election, letting them know who did and did not vote. When compared against the level of voter turnout in a control group that received no turnout treatment or intervention of any sort, the treated voters turned out at a rate 8.1% higher than the voters in the control group.¹ ¹ Gerber, Alan S., Donald P. Green & Christopher W. Larimer (2008) “Social Pressure and Voter Turnout: Evidence from a Large-Scale Field Experiment.” American Political Science Review 102(1): 33-48.

The Project Applecart Strategy: Taking a Proven Tactic into the 21st Century

While the scientists' experiment achieved a remarkable result, systems and methods according to the present invention make significant enhancements to this strategy so as to dramatically increase the tactic's overall efficacy and harness its mobilizing power to turn out infrequent voters in numbers larger than all other methods and competitors. Applecart has produced the only recorded voter turnout increase to have ever exceeded the one generated by the original scientific experiments.

In a first demonstration of the technology the inventors nearly doubled this percentage turnout in a randomized and controlled experiment conducted in a May 2014 primary election in a Midwestern American state.

In exemplary embodiments of the present invention, a three-step process may be used:

1. First, advanced microtargeting techniques may be deployed to isolate the populations of infrequent voters most likely to support a preferred candidate or issue. Only the voters in that population will be targeted for mobilization.

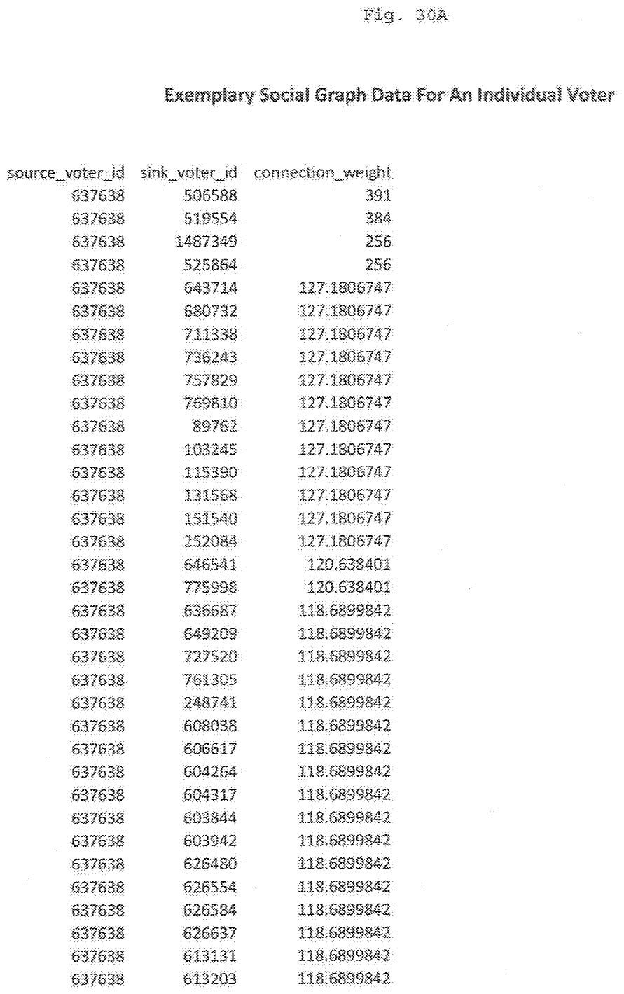

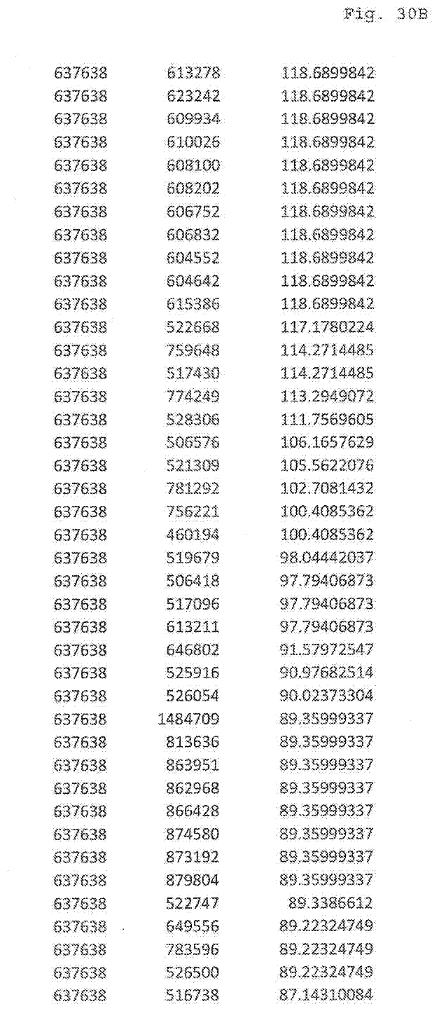

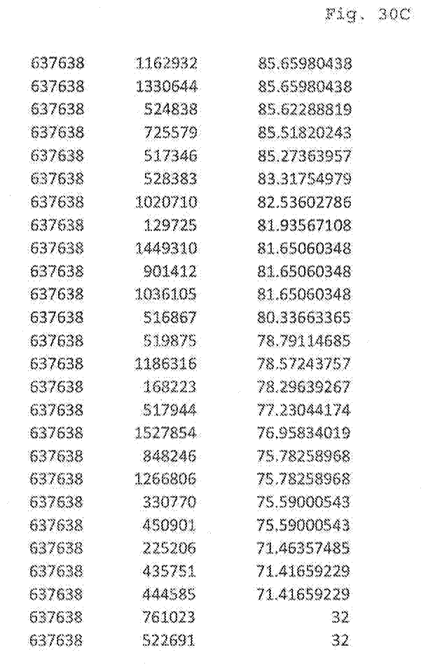

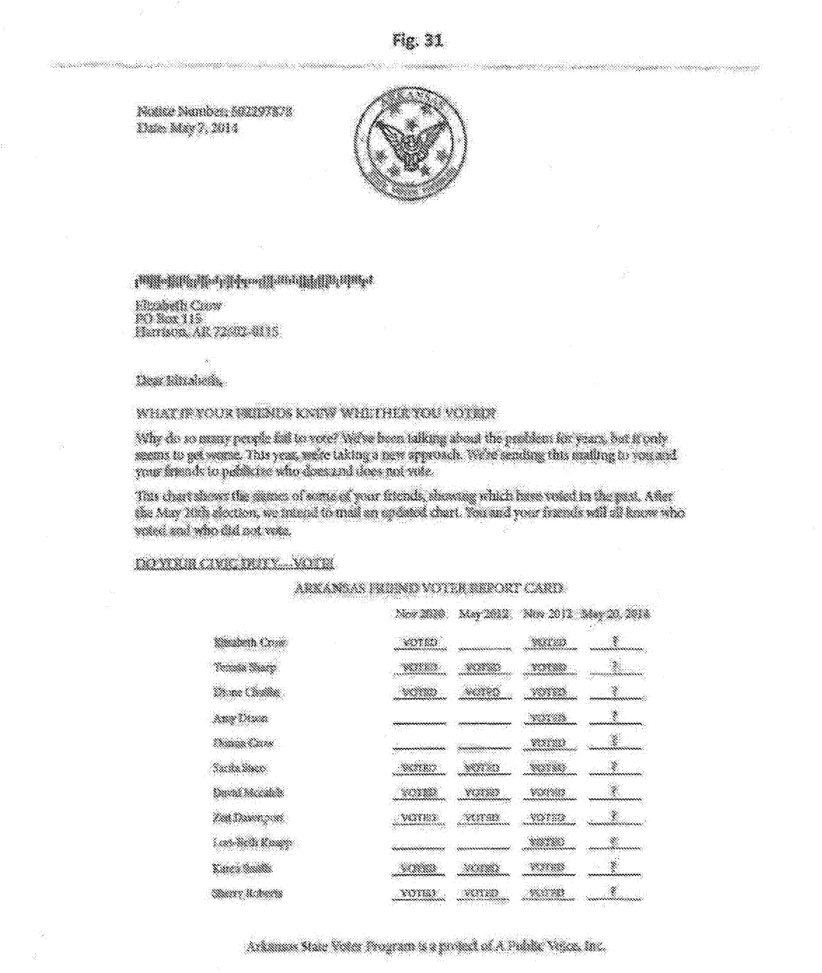

2. Noting that the scientists who conducted the original research contacted target voters with their neighbors' voting records, delivering the far more salient voting records of the voter's close friends, family members, peers, and colleagues. Using an algorithmic process, Project Applecart is able to construct a detailed social graph for nearly every American voter (see FIG. 30). This improvement enables the delivery of a more targeted message to voters that mobilizes a larger portion of the infrequent voting population than ever before (see FIG. 31).

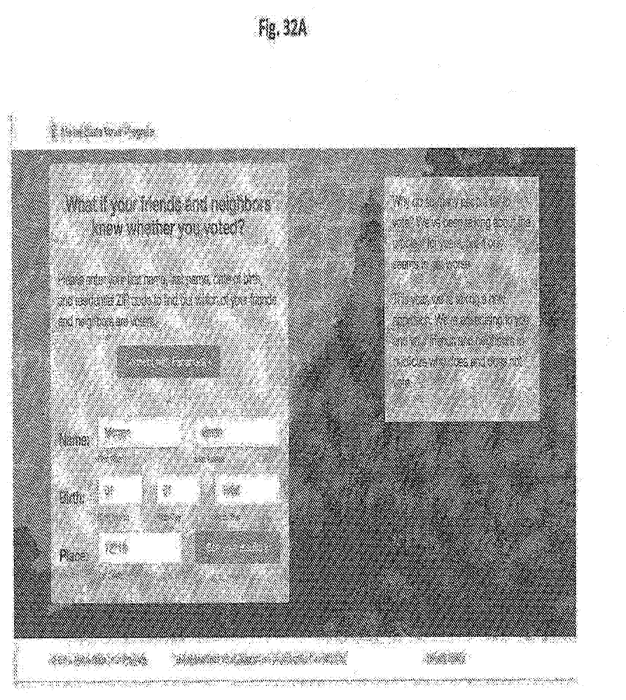

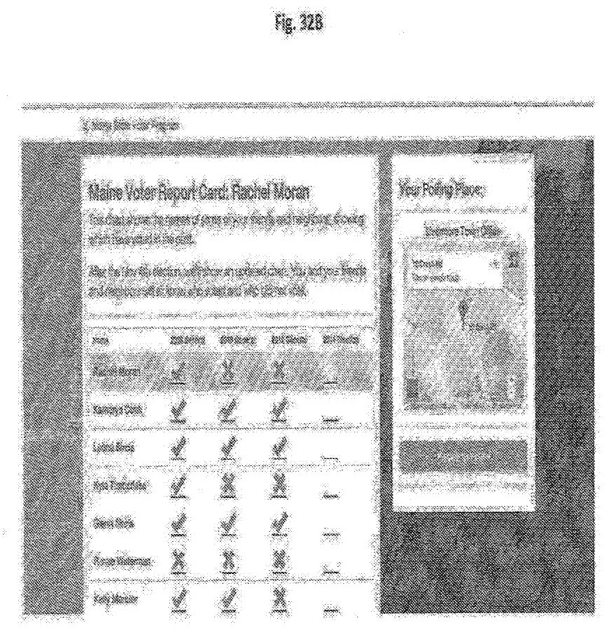

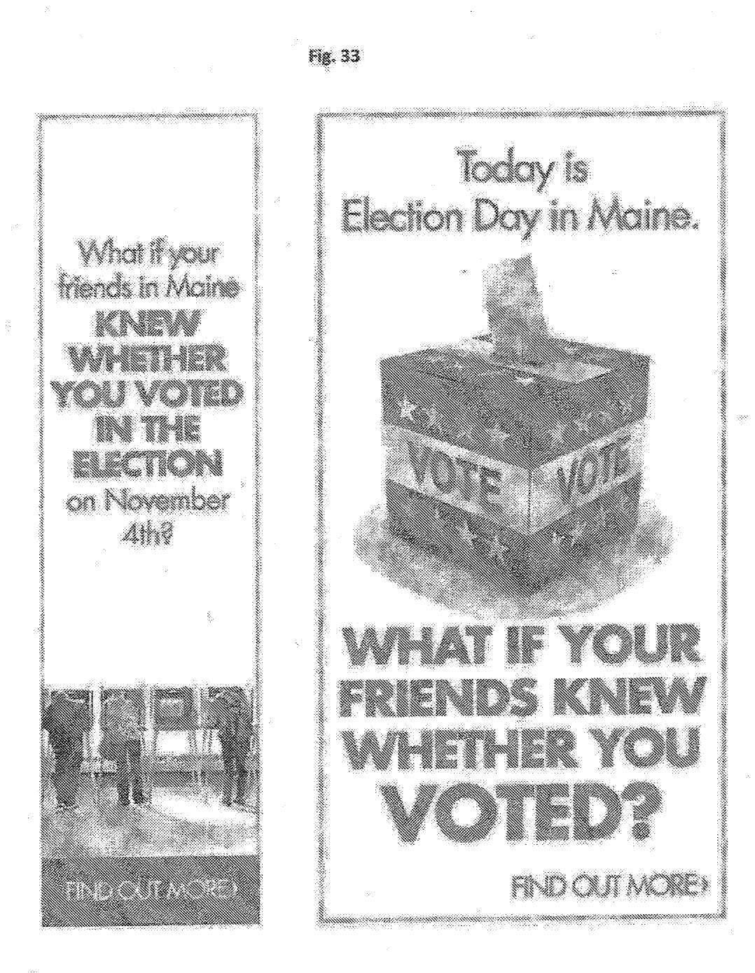

3. Supplementing the proven effectiveness of “snail mail” voter mobilization with cutting edge digital distribution channels. By delivering the same individualized social graph message, in addition to direct mail, via individually targeted cookie-matched display, banner, and mobile ads that direct targeted voters to an online interface that allows them to view their social graph treatment, as well as individually targeted email contact with the same messaging as is contained in the direct mail contact Applecart can successfully mobilize even more voters with the same highly targeted message at very low costs (see FIGS. 32-33).

In order to achieve the greatest impact in a given district, exemplary embodiments of the present invention mobilize voters that meet the initiative's targeting criteria and exclude from the mobilization effort those voters that do not meet the targeting criteria. For example, in the instance of a primary election, the user may attempt to mobilize moderate voters in the district to help elect a more moderate congressman without mobilizing their more ideologically extreme neighbors. Using conventional modeling and micro-targeting techniques that are widely used by campaigns and other organizations and were first developed for the 2004 Election Cycle by the Republican National Committee in concert with TargetPoint Consulting², voters can be classified by their particular strand of moderate politics based on a voter model that can be custom-built for the district. Such a customized model thus enables more moderate registered voters to be distinguished from their more extreme neighbors. More specifically, an exemplary model can be used to separate out those voters most likely to vote for a more moderate candidate than the candidate favored by these voters' more extreme neighbors. As noted, in exemplary embodiments of the present invention, only those registered voters identified as more moderate can, for example, be targeted for mobilization. Please note, this sort of targeting can be used to identify voters based on any ideology, issue position, or other identifying factor. ² http://www.gwu.edu/˜action/2004/bush/microtargeting.html

In exemplary embodiments of the present invention, the process of constructing such a model, custom-built for a particular district, requires taking a large scale poll of the district and hundreds of demographic and consumer data points on every registered voter. The poll can, for example, ask (i) several demographic questions, (ii) several questions about a respondent's feelings about the candidates in a target race, and (iii) several questions gauging the respondent's reaction to specific wedge policy issues or policy language used by the candidates. A model can then be built based on the results of this poll, and can then be applied to all of the voters in the district (including those who were not polled) to determine their likelihood of voting for a preferred moderate candidate versus a more extreme challenger.

Once the targeted moderate voters have been identified, an individualized message can be constructed for, and sent to, each targeted voter. Such a generated message can present the targeted voter's voting record along with that of the voter's close friends, colleagues, family members, and other social influencers, all of whom are the individuals in the target voter's social graph whom are most likely to exert the “social pressure” sufficient to provoke the targeted voter to cast their ballot. This technique can be very useful, as it has been shown that by providing the voting records of those closely known to a given targeted voter, the likelihood that the targeted voter will in fact vote is dramatically increased. Once again, this principle was first established with regard to neighbors' voting records in Alan S. Gerber, Donald P. Green, and Christopher W. Larimer, Social Pressure and Voter Turnout: Evidence from a Largescale Field Experiment, American Political Science Review (February 2008) and improved upon by the present invention to establish the efficacy of replacing neighbors with a social graph, as was first proven in Applecart's May 2014 primary election randomized controlled experiment.³ ³ available online at: http://www.apsanet.org/imgtest/apsrfeb08gerberetal.pdf

In exemplary embodiments of the present invention, after the individualized message is generated, it can then be transmitted to the targeted voters (e.g., those identified by the model to be substantially more likely to vote for the desired candidate), via a combination of direct mail, e-mail, and digital outreach, including banner, display, mobile, and social media on-line advertising that direct voters to an online interface that permits targeted voters to view their social influencers' voting records online. On average, Applecart is able to match nearly 60% of targeted voters to individual-level online cookies to which the user serves approximately 35 impressions to each targeted voter, on which the clickthrough rate to the online interface is 0.085%-0.30%, a significant multiple of interaction rates seen by more conventional political digital advertising. Simultaneously, of the over 30% of the average target population for which Applecart has an email address, approximately 15% of the target population opens an email by the end of the campaign and the targeted voter is removed from the email list once they open an email once.

As a result, in exemplary embodiments of the present invention, a larger portion of the previously untapped targeted voter base population in a given voting district can be mobilized than can be mobilized using existing techniques.

It has also been established that the overall electorate is generally composed of liberal, moderate and conservative voters. Of these three general categories, a wide body of public and private polling demonstrates that moderates form the vast majority of the American electorate.⁴ In exemplary embodiments of the present invention, these moderate voters can, for example, be targeted for outreach with an individualized political message. On the other hand, in such exemplary embodiments, if the purpose of the use-case is to mobilize moderate voters, voters who are already likely to show up and vote on Election Day, and those who also likely hold strong views on political issues, may not be targeted for mobilization. It should be understood, however, that in alternate exemplary embodiments, the systems and methods of the present invention could be used to target any segment of the voter population, including very liberal, very conservative, and/or highly ideological voters, or voters who identify with a specific policy position. ⁴ See, for example: http://www.msnbc.com/morning-joe/meet-the-moderates

It is known that the vast majority of more moderate, unaffiliated, or less active voters are not typically motivated to vote by an explicit political interest in specific races. Instead, when these voters turnout in more salient elections, such as presidential races, it is frequently a response to the communal consciousness, energy—or “buzz”—surrounding the election: the notion that because their friends, peers and neighbors vote, they should vote as well. Conventional political mobilization efforts still do not understand that traditional legislative and political appeals do not mobilize these less frequent voters. As a result, many political campaigns are excessively expensive, as they spend large sums on outreach efforts that are mis-messaged, and thus largely counterproductive. In the 2014 election cycle, the New York Times reported that television advertising spending in races around the country to support voter mobilization effort during the final week of the campaign reached an average of at least $20 million a day, for a total of over $140 million just in the last week.⁵ The present invention offers the capability to mobilize infrequent, less active voters with dramatically greater cost-efficiency and lower overhead. ⁵ http://www.nytimes.com/2014/11/03/us/politics/a-flood-of-late-spending-on-midterm-elections-from-murky-sources.html?_r=0

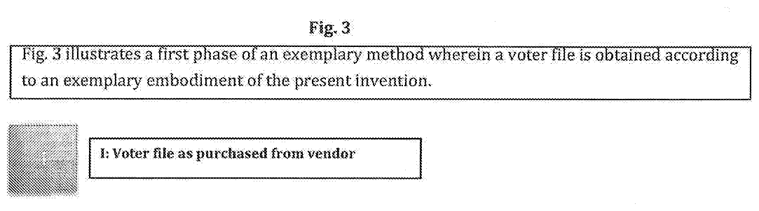

As shown in FIGS. 3-8, in exemplary embodiments of the present invention, there are several phases involved in ultimately assembling the targeted voter information, enhancing it, creating messages for the targeted voters, and delivering those messages so as to motivate and mobilize the targeted voters. Each phase involves obtaining or processing a voter file in some way. In FIGS. 3-8 these various phases which the voter file takes on are referred to as I-V. They are designated as follows:

I. Voter file as purchased from voter file vendor;

II. Voter file as needed for voter targeting;

III. Voter file as needed for social data collection;

IV. Voter file as needed for treatment production; and

V. Voter file as needed for treatment delivery.

In exemplary embodiments of the present invention, information from various voter data sources can be aggregated as needed to model the individualized message most likely to mobilize a desired voter to the polls. In exemplary embodiments of the present invention, voter information can be collected from a variety of sources. As shown in Phase I, shown in FIG. 3, a voter file can be purchased from a voter file vendor. In this connection it is noted that there are several vendors who sell voter files, such as, for example, i360, Data Trust, Aristotle, Catalist, and Labels & Lists.

In the context of creating a detailed voter file, it is noted that there are a number of data sources available for obtaining voter information including, for example: (B) phone vendors; (C) cell phone vendors; (D) email address vendors; (E) PiP| online directory; (F) manual collection from social networks; (G) GraphMassive (social connection vendor); (H) IVR pollsters; (I) voter file vendors; (J) IP address/cookie-matching vendors; (K) American National Election Studies and other existing electoral research; (L) basic treatment creation shop (internal); and (M) enhanced treatment modeling and creation shop (internal).

Details of these data sources are as follows:
B: Phone vendors use names, addresses, e-mail addresses, and other demographic information to return landline phone numbers for individual voters and voting households;
C: Cell phone vendors use names, addresses, e-mail addresses, landline phone numbers, and other demographic information to return cellular phone numbers for individual voters and voting households;
D: E-mail address vendors who can use names, addresses, landline phone numbers, cell phone numbers, and other demographic information to return e-mail addresses for individual voters and voting households;
E: Online directories that can use name, age, address, landline phone number, cell phone number, and e-mail address information to return social profile web URLs and social profile user ID numbers;
G: Vendors who can provide online social connections between individuals based on their e-mail address;
J: IP address/online cookie ID vendors who can match an individual's non-personally identifiable online cookie ID that can be used to serve customized online advertisements to an individual's name and address in a voter file;
K: Series of large-sample, regularly conducted polls and studies to measure general political attitudes by granular demographic group, such as, for example, those conducted jointly by Stanford University and the University of Michigan with funding from the National Science Foundation;
L: Internal utilities for combining address/geolocation information with individuals' publically available voting histories to create customized mobilization messages making use of an individual's residential neighbors' histories, to be delivered by mail, as well as by e-mail and online advertisement when necessary because more salient social graph treatments cannot be created; and
M: Internal utilities for combining social connection information with individuals' publically available voting histories to create customized mobilization messages making use of an individual's social connections' histories, to be delivered by mail, as well as by e-mail and online advertisement when possible.

In exemplary embodiments of the present invention, there are a number of exemplary data types or data fields which can be used to characterize a voter, or build a record for voters in a database. These data fields can include, for example: (1) full name; (2) demographics; (3) voting history and political affiliation; (4) consumer information; (5) home and mailing address; (6) phone number; (7) cell phone number; (8) e-mail address; (9) social network identification; (10) polling data; (11) friends and other social connections; (12) cookie-matched IP addresses; (13) targeting scores (synthetic); (14) existing research data; (15) enhanced treatments (synthetic); and (16) basic treatments (synthetic).

In various exemplary embodiments, data fields (1) through (16) above can be specified as follows, and sourced as indicated:

1: first name, middle (if applicable) name, last name, and suffix (if applicable) as obtained from public voter rolls purchased through a voter file vendor;

2: gender, race, cohabitation status (as determined by shared last names and shared addresses) as obtained from public voter rolls purchased through a voter file vendor;

3: records of participation in previous local, state, and federal elections; records of the form of participation (i.e. at the polls on election day, at the polls during early voting, by absentee ballot, etc); records of partisan affiliation (if any); record of date of registering to vote; record of any changes submitted to the relevant registrar of voters; as obtained from public voter rolls purchased through a voter file vendor;

4: individual consumer information, collected based on individual magazine and catalog subscription habits, trackable online purchase and browsing behavior, credit card activity, etc., as aggregated by a voter file vendor from a variety of different data collection firms such as, for example, Acxiom or Experian;

5: home and mailing address, as obtained from public voter rolls purchased through a voter file vendor; updates and changes to home and mailing addresses, as obtained through the USPS National Change of Address database through a direct mail house and from a voter file vendor;

6: landline phone number, as obtained from public voter rolls purchased through a voter file vendor or as obtained from a variety of different data collection firms such as, for example, Acxiom or Experian;

7: cellular phone number, as obtained from public voter rolls purchased through a voter file vendor or as obtained from a variety of different data collection firms such as, for example, Acxiom or Experian;

8: e-mail address, as obtained from public voter rolls purchased through a voter file vendor or as obtained from a variety of different data collection firms such as, for example, Acxiom or Experian;

9: individual social network profile URLs and individual social network profile unique user IDs, as obtained, for example, through online directories like PIPL or through manual search using the utilities provided by social networks;

10: responses to large scale live and robotic surveys surrounding relevant political attitudes towards candidates, issues, and policies, as collected by pollsters;

11: real-world connections between individuals based on their social network connections or modeling and mining processes that are applied to all manner of unstructured data that can be found both on the internet and in the physical world, as obtained by social connection vendors or intelligent search and collection procedures, web crawlers to be used on irregular web data (not social networks) such as news sources and newspaper archives, and in person research to be used on irregular physical data sources such as high school yearbook collections, and as modeled through various algorithmic approaches;

12: IP addresses as matched to online “cookies” that allow Internet advertisers to customize the content of their advertising on an individual granular basis; as obtained from consumer information firms such as, for example, Acxiom;

13: algorithmic voter targeting scores, as developed using a combination of demographic information, consumer habit information, and polling data; created on a geography-by-geography basis to identify the ideologically-ideal voters for mobilization in a targeted race;

14: results from a series of large-sample, regularly conducted polls and studies to measure general political attitudes by granular demographic group; other publically available polling information relevant to a target geography or targeted electoral race;

15: completed voter mobilization messaging based on proven social connections and social connection modeling, customized for a specific individual and prepared for delivery along with all of the necessary creative content and addressing information for each channel or method of delivery; and

16: completed voter mobilization messaging based on proven geolocation-based, neighborhood-based relationships, customized for a specific individual and prepared for delivery along with all of the necessary or desirable creative content and addressing information for each channel or method of delivery.

Once a voter file has been obtained, in a second phase the voter file information can be analyzed and processed to meet the needs of the political campaign for targeting desired voters. Alternatively, a user of the present invention may be provided an external already constructed targeting model for use throughout the remainder of the process. Thus, for the purposes of discerning precisely which voters to target with the present invention, for example, the voter file can be processed to produce models that identify any given voters (1) ideology, (2) propensity to vote and (3) the likelihood that the targeted voter will respond to outreach.

This processing can, for example, be implemented as follows:

(1) “processing the voter file by ideology”—an algorithmic model (the result of which is a numerical “likelihood of supporting score” on a 0-100 scale) can be built that takes as inputs demographic information, residential and mailing address, party affiliation, membership information as to groups or associations that indicate ideological leanings (e.g., NRA, ACLU, environmental groups, etc.), political contribution data, individual-level consumer data, publicly available study information from the ANES, and polling results from internally conducted polls. This information can then be used to predict the ideological likelihood that any given voter will support a specific candidate or ballot question in a targeted geography and election.⁶ ⁶ View here online for an example of the process for this type of model creation in Strata: http://www.stata.com/meeting/dcconf09/dc09_aida.pdf

(2) “processing the voter file by propensity to vote”— an algorithmic model (the result of which is a numerical “likelihood of voting score”) can be built that takes as inputs demographic information, partisan affiliation, individual-level consumer data, political contribution data, publicly available study information from the ANES, polling results from our internally conducted poll, and individual voter participation histories from public records. This information can then be used to predict the likelihood that any given voter will mobilize and vote on a specific targeted election day without additional stimulus, treatment, or contact.⁷ ⁷ See note reference number 7

(3) “processing the voter file by likelihood to respond to mobilization outreach”— an algorithmic model (the result of which is a numerical “susceptibility to mobilization score”) can be built that takes as inputs demographic information, partisan affiliation, individual-level consumer data, publicly available study information from the ANES, polling results from our internally conducted polls, previously conducted internal polls for other geographies, individual voter participation histories from public records, aggregate mobilization results from previous mobilization efforts in other electoral geographies, and aggregate combinations of channels and treatments used in those previous mobilization efforts. This information can then be used to predict the specific mix of advertising creative content and distribution channels that will maximize the chances that a targeted voter will mobilize and vote on a specific targeted election day.

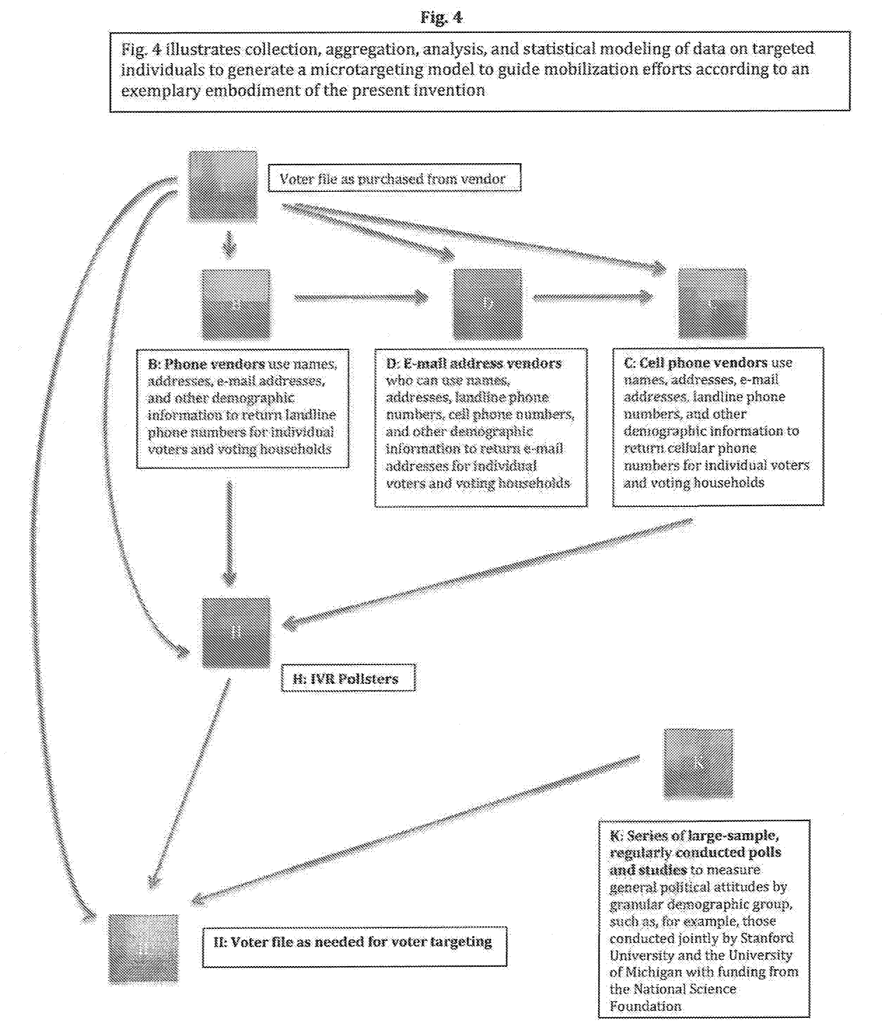

FIG. 4 illustrates processing a basic voter file I that may be used to obtain a mobilization model II. With reference thereto, at the top of the figure is shown the collection of additional cellphone and landline information to ensure as unbiased a polling sample as possible. This can be done, for example, by purchasing cellphone numbers C, purchasing landline numbers B, and purchasing email addresses D to facilitate purchase of cellular/landline numbers B, C.

Thus, combining voter file data I with additional phone contact information B, C, allows a large scale benchmark poll to be conducted. Polling data H can then be combined with electoral study data K to create mobilization model II, an enhanced voter file. It is noted that in exemplary embodiments of the present invention, the mobilization model can include, for example, (a) a list of top ideological targets based on the “ideology model” (e.g., moderates, pro-gun control voters, pro-life voters), from which is deleted (b) the set of voters with a high propensity to vote, all combined with individual vote history data from elections where the present invention was used previously. In analyzing which infrequent voters activated to vote during previous applications of the present invention in concert with identifying which types of voter contact each of these voters received, a model can be constructed that identifies which populations of voters when contacted with which combination of types of voter contact are most likely to vote. Therefore, an outreach model can be built that determines a form of outreach most suited for a given individual and which populations of voters are most responsive to the present invention's mobilization stimulus. The exact specifications of this kind of outreach model are trade secret, but for the purposes of the invention, it is only necessary to know that the results of previous deployments allow us to gain an understanding of which voters are susceptible to a social pressure approach or to responding to a specific form of contact.

In exemplary embodiments of the present invention, the data used to generate the mobilization model can be combined, for example, using adaptations of a number of proven and commonly accepted statistical methods, including but not limited to: (i) two stage cluster sampling, (ii) block randomization sampling, and (iii) multivariable regression. This information can also be combined using adaptations of a number of proven and commonly accepted machine learning (“data mining”) methods, including but not limited to: (iv) decision trees, (v) Bayesian networks, (vi) unsupervised K-means clustering, (vii) unsupervised expectation maximization clustering, and (viii) principal component analysis. The result of the application of the appropriate implementation of these various statistical packages on a database of the aforementioned data types is a 0-100 score that identifies which voters are most likely to support preferred candidate or legislative initiative that the user of the present invention intends to mobilize voters to support.

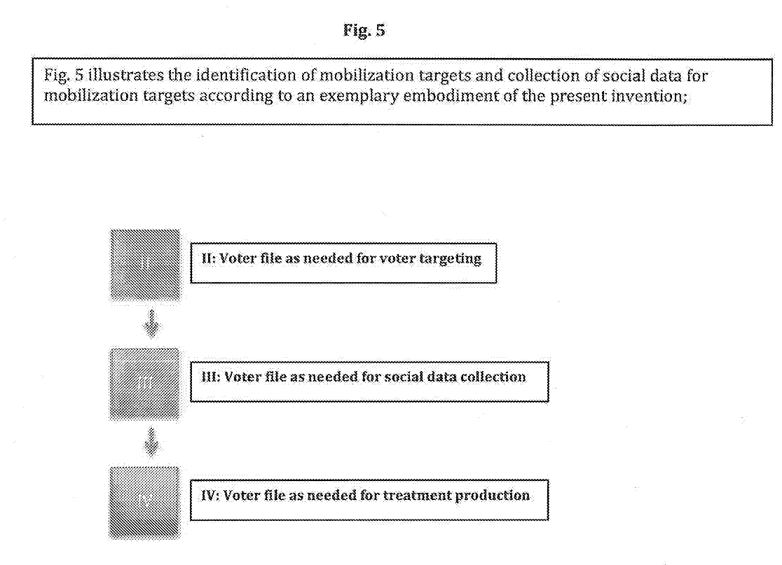

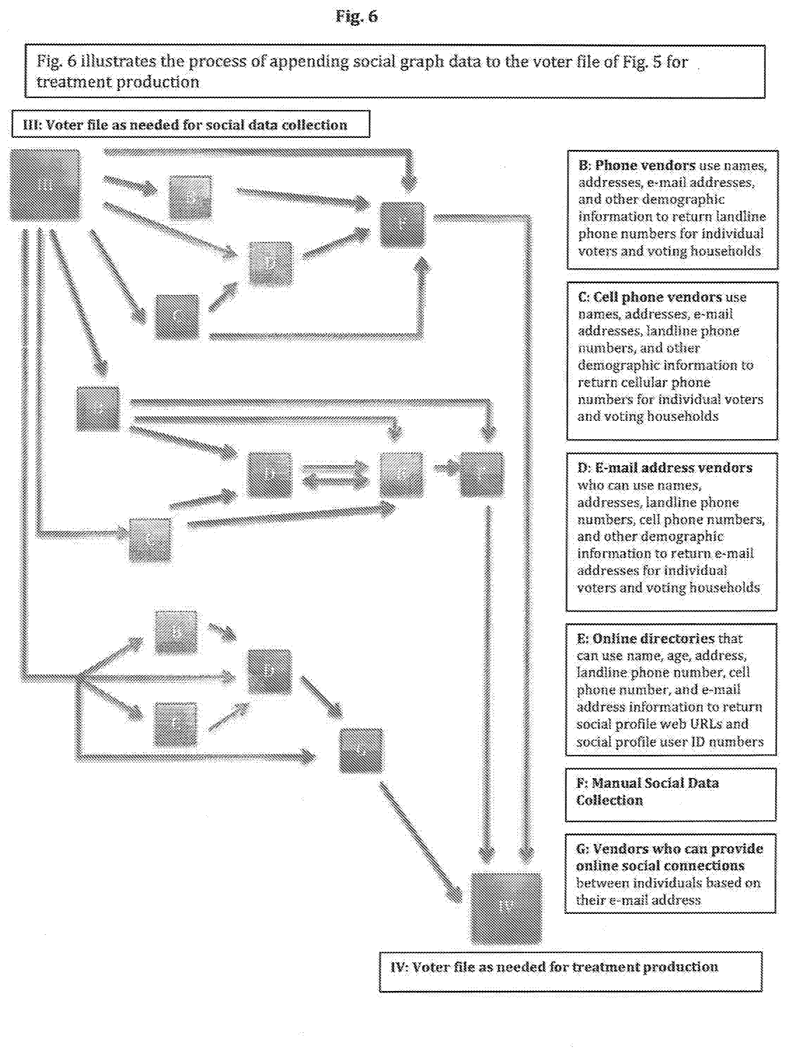

In Phase III, the mobilization model II can be further processed using social data collection. Social data can, for example, be collected for the targets III and applied to the voter file in advance of programming individualized messaging IV. This is illustrated, for example, in FIG. 5. Here, as noted above, mobilization targets III can be determined by modeling: (i) a support score for the specific candidate/issue in question; (ii) a score measuring likelihood to vote under existing conditions; and (iii) likelihood to positively respond to treatment with messaging.

This processing can thus include, for example, appending targeting scores and separating non-targets from targets. Additionally, in exemplary embodiments of the present invention, existing information on voters can be enhanced with social connections for as many people as possible so that a socially-inspired mobilization message can be delivered.

In this context, the process of distinguishing a “target” from a “non-target” can be thought of as just adding a column to the “spreadsheet” of voters (or a mySQL database) for the calculation of a “targeting score”, resulting from the aforementioned models, a number from 0 to 100 that would identify those voters who are “surest bets” ideologically and those who are absolute “no-gos”, and then assigning these targeting scores to new column in the mySQL database so that the user can identify those voters for which individualized social graph treatments must be created and eliminate those voters for which treatments should not be created because they should not be mobilized. At the same time, recognizing that some people have many more social connections than others, and relatively few people have the exemplary voting records that would be shown to targeted individuals through mobilization messaging, an exemplary voting file list can be rank-ordered for searching social profiles based on putting those with the best voting records AND the most friends first. Searching for friends of one individual with a perfect voting record and 2000 social connections can, for example, provide one tenth of a completed mobilization treatment for any of the 2000 connections who is geographically and ideologically within the target group. At the same time, searching for friends of one individual with an infrequent voting record and 100 social connections may only yield connections to that individual's friends with exemplary voting records that may be desirable to display in ad advertisement or message to this one target. Only by rank-ordering an exemplary social connection collection, and modeling efforts in this fashion, can social connection data be provided for an entire population of several hundred thousand voters in a remotely cost-efficient fashion. It should also be noted that social graph treatments should not completed entirely with exemplary voting records, while they should be weighted toward exemplary voting records, incorporating less admirable voting records is also important to conveying the idea to the targeted voter that their poor voting record is most likely present on the voter contact that other targeted voters in their community are receiving. In one exemplary embodiment, the user could construct voter contact treatments consisting of 7 social influencers with perfect voting records (voters who had voted in every possible election), 1 social influencer who has never voted, and two social influencers who have voted in one or two out of the last three major general elections. However, in alternate exemplary embodiments, the distribution should be adjusted to reflect the circumstances at hand—suffice to say, the distribution of the social influencers incorporated in the message is significant.

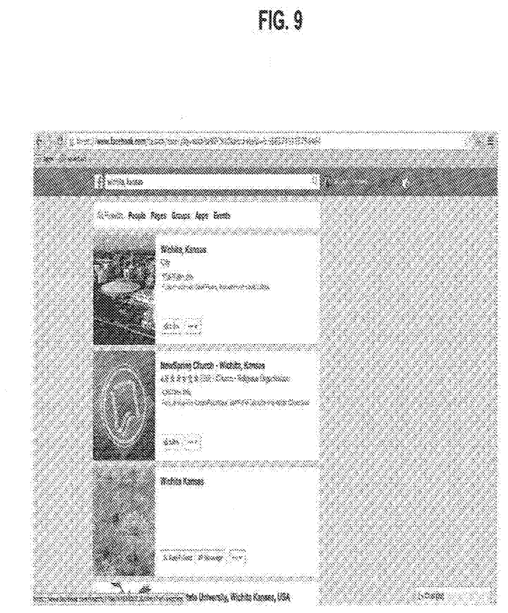

FIG. 6 illustrates details of social data collection, and the appending of the same to an exemplary voter file. FIG. 6 thus illustrates three options for enhancing voter information with social connection data. One exemplary option, shown at the top of FIG. 6, is a brute force option which uses the full name, city of residence and other available information from the voter file by a team of trained staff who can search appropriate social networking sites and collect relevant friend connection information—shown as “F”—on the targeted voter. This option is based on a good faith attempt to comply with the stated “terms of service” of the various social networks. For example, Facebook's terms of service state explicitly that users (and thus potential employees) commit to not collecting users' information via automated means without prior permission. Thus, agents may manually collect social connection data through individual searches that make use of Facebook's existing “graph search” tool. This option also may include, for example, an intermediate step of converting names and addresses to phone numbers and/or e-mail addresses. This process is described in greater detail in connection with FIGS. 9-29.

Another exemplary option for enhancing voter information with social connection data is a more streamlined approach, in which an entire voter file can, for example, be run through a database of an online information vendor, such as, for example, PiPL. This is shown as the middle network in FIG. 6, where PiPL is represented as “E.” Under this approach, PiPL returns an extracted URL for a targeted voter's social media public profile (e.g., Facebook, LinkedIn or other similar networking site). After gathering these URLs, they can be visited systematically by staff as in the option above in order to gather friend connections “F”. This option is preferable to the manual search option as it is automated and thus faster and less expensive to implement. The manual search option may be preferred for those targeted voters who cannot be found automatically because of, for example, privacy settings which prevent PiPL from gathering the URL information. Names, addresses, contact information, and necessary demographic information may be run through the PiPL online directory to return social network profile URLs and unique user IDs that can in turn be appended to the voter file. That being said, it is noted that each social network has its own privacy settings and one of the most commonly available (but rarely used) settings limits the viewability of a profile to search engines like Google and Bing or databases like PiPL.

A third exemplary option for enhancing voter information with social connection data is to purchase friend connection data from a vendor, such as, for example, GraphMassive or other vendors providing similar services. This is illustrated in the bottom network of FIG. 6, where such a vendor is represented by “G.” GraphMassive takes e-mails as inputs and returns connections between e-mail addresses, shown here as “F”. GraphMassive sells connections between online individuals directly—accepting e-mail addresses as inputs and returning any other provided e-mail addresses to which they are connected or related. It is not publicly known how GraphMassive performs this function.

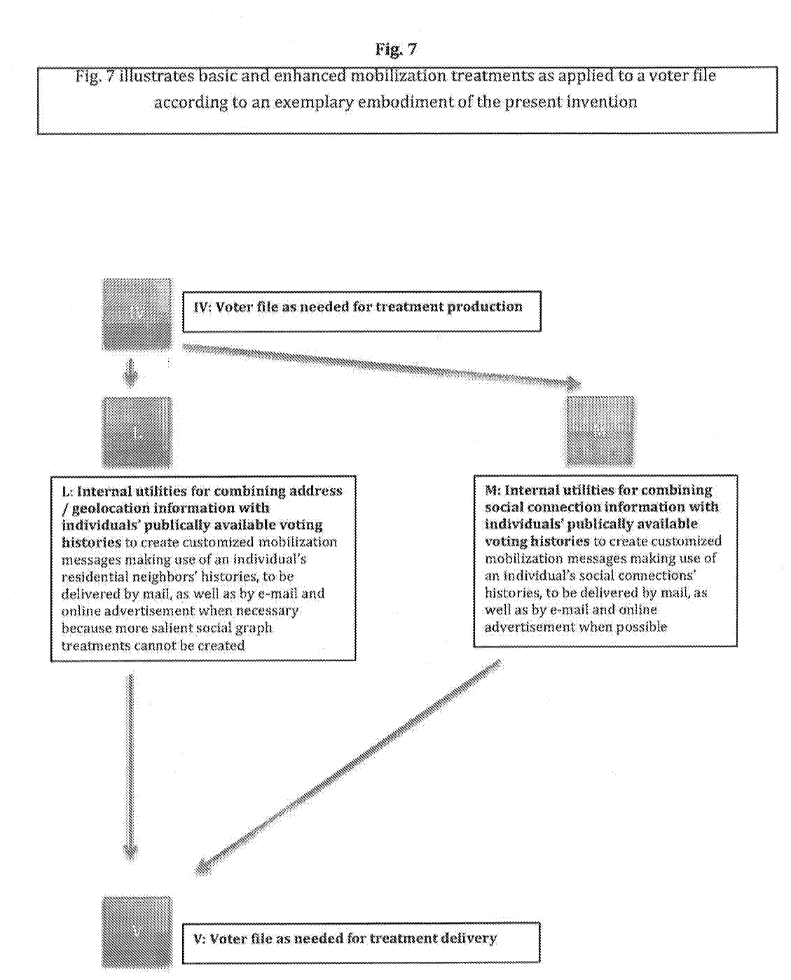

As noted, in a fourth phase, an exemplary enhanced targeted voter file IV can be processed to facilitate treatment production. The result of this processing is a treated voter target file V. This processing is illustrated, for example, in FIG. 7. A basic treatment follows a pathway from IV to V through L, and an enhanced pathway is represented by processing voter targets IV via M to obtain V. This processing includes, for example, adding friend and connection data where available. This phase also includes selecting, for each target, the social connections having the appropriate ratio of exemplary voting records to less than perfect voting records and then compiling those voting records together with the names of the target and his/her social connections into their own file. Enhanced treatments are based on delivering social connections' voting records, whereas basic treatments are based on delivering the neighbors and family members voting records for those individuals who do not have an identifiable or calculable social graph presence.

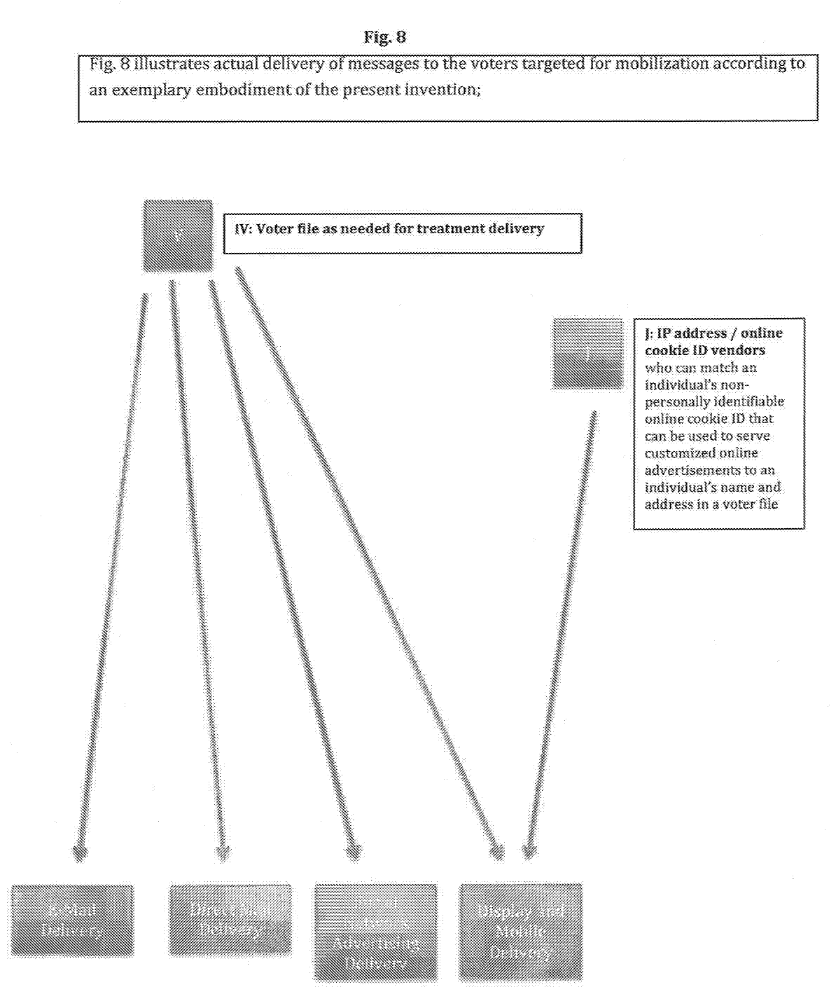

In a fifth and final phase, the voter file can be processed to facilitate treatment delivery, which includes the sending of individualized messages to the targeted voters, the messages including voting information as to their various influencers. This is illustrated both in FIG. 8, and in greater technical depth in the exemplary script provided below entitled “Voter File Delivery Processing.” This processing may include, for example, completing basic and enhanced treatments, as noted above, and delivering the messages. Once the individualized mobilization messaging is completed, it can be processed into slightly different forms for delivery via various channels, such as, for example, direct mail delivery, e-mail delivery, social network advertising delivery, display and mobile delivery, and other digital channels as may be appropriate.

Social Connections Discovery

As noted, a key aspect of various exemplary embodiments of the present invention is an accurate identification of the key influencers of an individual, such as a voter. To obtain this information, various social media data may be mined and analyzed. FIGS. 9-14, next described, illustrate social connections discovery according to exemplary embodiments of the present invention, in particular, using Facebook as an example.

These figures illustrate how social connections between individual targeted voters may be developed by making use of the tools and infrastructure that Facebook provides to all of its users for free and without restriction. The collection process was developed to efficiently optimize human interaction with Facebook's systems for the purposes of conducting social connection research. The exemplary process prioritizes best efforts compliance with Facebook's Terms of Use, thus explicitly avoiding automated methods such as web scraping or crawling. In what follows, a numeral in parentheses, e.g. “(1)”, represents an earlier step in the collection process.

Step 1—Associate Each Specific Geographic Location in the Voter File with the Facebook ID Number for that Geographic Location and Run Each Location Through a Geo-Mapping Database to Assign it a Latitude and Longitude that would be at the Center of the Location.

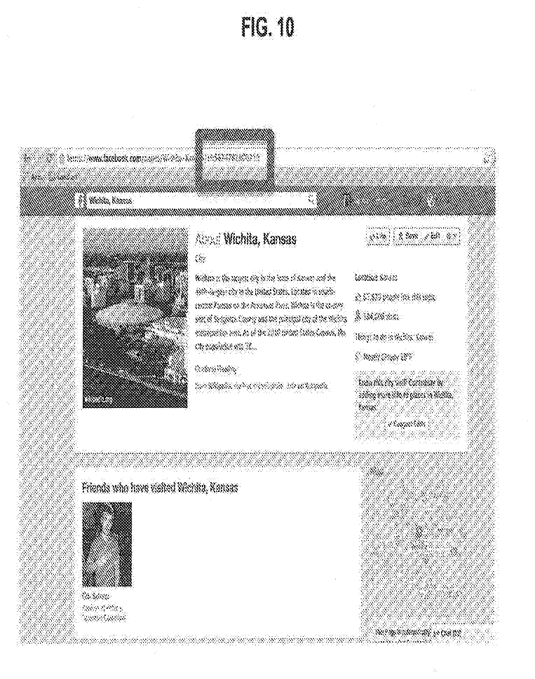

Facebook is not just a social network; in reality it should be thought of more as a search engine for places and ideas in addition to people and corporations. Accordingly, the vast majority of geographic place names have their own “Facebook page”. Take, for example Wichita, Kans. If one does a search in Facebook's search toolbar for “Wichita, Kans.”, one sees results similar to those shown in FIG. 9. Clicking on the result for the city of Wichita, denoted by the words city, will lead you to a page like the one shown in FIG. 10. While Facebook's GUI (graphical user interface) presents information on the city in written terms (how many “likes” the city has, how many people have “checked in” there, what the current temperature is, etc.), the city itself is associated with a specific ID number that Facebook assigns to it—a number that can be located in the URL for the page, as shown in FIG. 10. The relevant portion of the URL is thus highlighted in red in FIG. 10. In the case of Wichita, that number is “105674782800210”.

This particular step of the process can be performed by manually entering each city for whom there is a voter (from the voter file) into Facebook's search bar, and copying the resulting id number into a spreadsheet. Alternatively, this can be done by making use of Facebook's public API to achieve substantially the same result. An API is an Application Programming Interface; more simply, a series of tools provided by a specific company that allow standardized programmatic access to their data and their capabilities through use of any one of a number of common programming languages. Facebook, as with most social networks, has put in place a robust and free API that allows efficient access to much of their publically available data, because much of their business proposition is based on allowing third party developers to create applications that interact with their online ecosystem and the data it contains.

Alternatively, a related but procedurally different step is running each geographic location through a database of latitude and longitude conversions, appending each to the name of the location. There are many companies that provide such services, such as, for example, MapLarge. This allows one to upload a .csv spreadsheet of location names, and then immediately returns a .csv spreadsheet of those locations with their appended latitude and longitude. While the specific vendor may change, this part of the process will remain largely the same in any variant embodiment.

Step 2—Making Sense of Facebook's System for Displaying Search Results when Searching for People, not Places or Companies//Making Sense of Facebook's Individual Profiles.

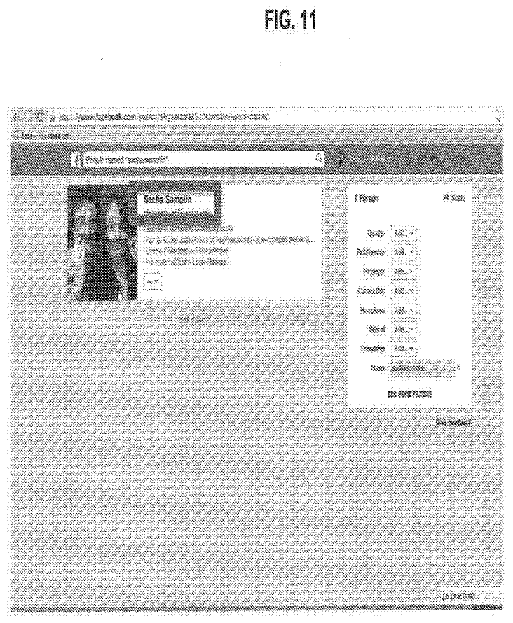

While Facebook's “graph search” toolbar can make considerably more complex queries of their social network than simply searching for place names or people's names, results of all searches for people are displayed in the same format. For example, try searching Facebook for “People named Sacha Samotin” returns a page that looks similar to that shown in FIG. 11. The format that Facebook uses to display the response to a search includes an entry for each profile that matches the search criteria (as allowed by the individual's chosen privacy settings). Each entry includes the profile owner's name as displayed on Facebook, a hyperlink to their Facebook profile, and a randomly varying assortment of other information such as where the person lives, where and when they went to school, what interests or places they've “liked”, and which (if any) of your “Facebook friends” are “mutual friends” with the specific person. The elements of each of these search entries that are most interesting are the entry's name, and the URL for the entry's profile. This URL contains the person's “Facebook vanity name” or “Facebook user id number” which may use as a unique identifier, and which can be used to navigate directly to a person's individual Facebook profile page. Using Sacha Samotin as an example, his “Facebook vanity name” is Samotin. Anyone who goes to “http://www.facebook.com/VANITY_NAME” or “http://www.facebook.com/USER_ID_NUMBER” should see Sacha's publically viewable profile—in this case http://www.facebook.com/samotin. The link that contains this URL can be found in the red box shown in FIG. 11. Understanding this standard format for results is integral to understanding how data collection processes works in exemplary embodiments.

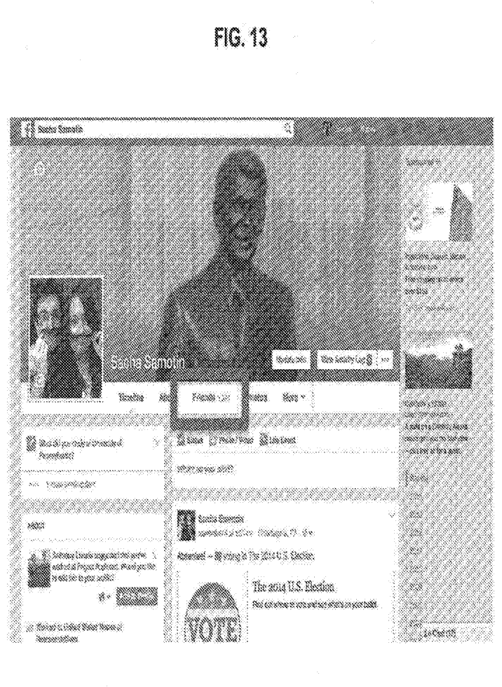

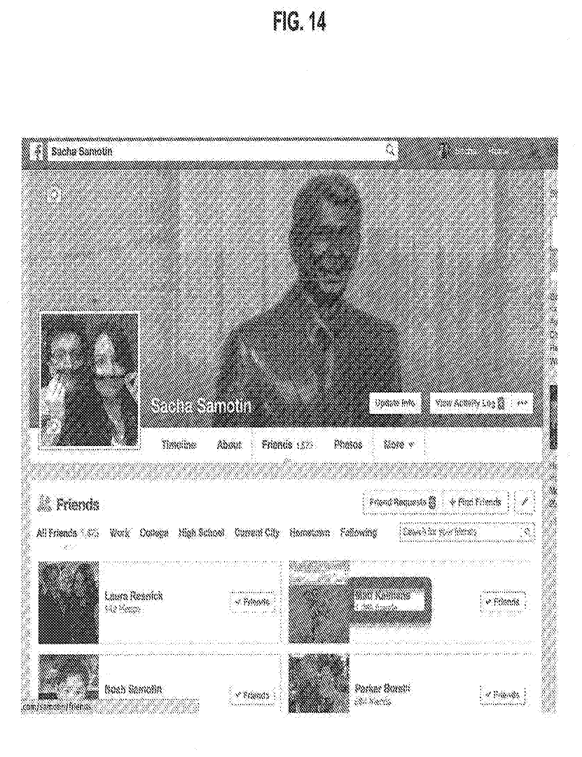

An individual person's Facebook profile is also maintained in a standardized format. Sacha's Facebook profile, for example, is shown in FIG. 13. The tab on the page that is most relevant is the “friends” tab, which navigates the visitor to a page that lists all of Sacha's Facebook “friends” (social connections) if they are publically viewable according to his privacy settings. The “friends” tab can be found as shown in FIG. 14. Similar to the search results discussed above, the friends page for any given profile contains entries for each friend. Each entry contains a link to the URL of that friend's Facebook page, also formatted as “http://www.facebook.com/VANITY_NAME” or “http://www.facebook.com/USER_ID_NUMBER”. The link that contains this URL can be found in the red box in FIG. 14.

Step 3—Create Batch Research Queries—“City Searches”—for Humans to Enter and Make Sense of, Based Off of the Associations Made in (1).

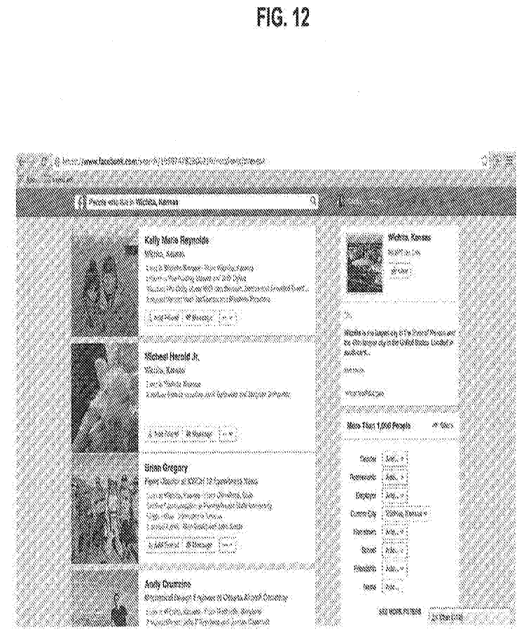

One query that Facebook's search toolbar understands allows one to see a sample of the people who have publically viewable profiles that live in or near a given area. For example, upon typing in “People who live in Wichita, Kans.” a page is returned that looks similar to FIG. 12. These “resident” pages contain information on many people with entries for the publically viewable profiles that identify themselves as residents of the given geographic location. It is not necessary to enter each phrase “People who live in [CITY, STATE]” manually into Facebook's search toolbar, because the searches themselves follow a standardized URL format. These URLs follow the format “http://www.Facebook.com/search/LOCATION_ID_NUMBER/residents/present”.

Navigating to the URL https://www.facebook.com/search/105674785800210/residents/present should take one to the same page that one would find by entering “People who live in Wichita, Kans.” into the Facebook search toolbar. Since we have already associated each city or place name with its Facebook location ID in Step (1), we can create batches of URLs to enter that follow the format described above, each of which will take us to the “resident” pages for the location in question. Facebook does place practical limits on the volume of information visible through these searches though. Individually adjusted privacy settings can restrict the amount of information available on the search entry for that profile, although they do not remove the result entirely. The inventors have also found that there is a limit of roughly 10,000 profiles that can be seen in each of these searches—so for cities with more than 10,000 inhabitants with Facebook profiles, this step in the process will only return a subset of the profiles that meet the given graph search criteria as results. While “city searches” are often the most efficient way to begin building the shell of a social graph for a given target geography, these practical limitations mean that “city searches” can only be a first pass to streamline the number and array of “individual queries” that must be researched. “Individual queries” are explained in more detail in Step 5 below.

All city searches may be performed by research associates via the Applecart Social Research Google Chrome Extension (as described below in Step (7).

Step 4—Associate “City Search” Results from (3) with Probable Matches in the Voter File.

Once the “city search” results are completed, the next step is to match each of the profiles contained within that “city search” result with a registered voter in our Voter File if there is an appropriate match. A computer script may be used to complete this process in batches to make it efficient. Thus, what follows is a description of the scripted process for a single profile found through a “city search”. First, we bring in the name and vanity name or user ID number associated with a given Facebook profile, and the location latitude and longitude associated with the “city search”. Next we search the voter file to establish a list of potential matches for that name based on two criteria: (i) the similarity of the name given by the Facebook profile to the name of the voter found in the voter file, and (ii) the geographic distance between the latitude and longitude assigned to the city that the profile is associated with and the residential latitude and longitude of the potential voter match. Each potential match is scored on the first criterion (name similarity) and on the second criterion (numeric distance). On the first criterion, exact matches between Facebook name and firstname+lastname or firstname+middlename+lastname are scored most favorably (lowest), followed by looser matches of these two name combinations that take nicknames and common variations into account (Ed or Eddie for Edward, for example), then exact matches of firstname+middlename and middlename+lastname, followed by looser matches of these two name combinations (highest). As the score for the first criterion increases and the name match becomes more tenuous for a match to be added to the potential list, the score cutoff required of the second criterion decreases—simply, the less certainty that we have that the names are actually likely to be attached to the voter, the more of a premium we put on having a smaller distance between the residential address of the voter and the city associated with the Facebook profile. Once this list of potential matches is compiled, the script associates the Facebook profile in question with the highest ranking voter in the voter file or with none if there is no suitably strong match.

Step 5—Create Batch Research Queries for Humans to Enter and Make Sense of, Based on the Combination of the Subset of Individual Records in the Voter File that Aren't Already Matched to a Facebook Profile, and the Associations Made in (1).

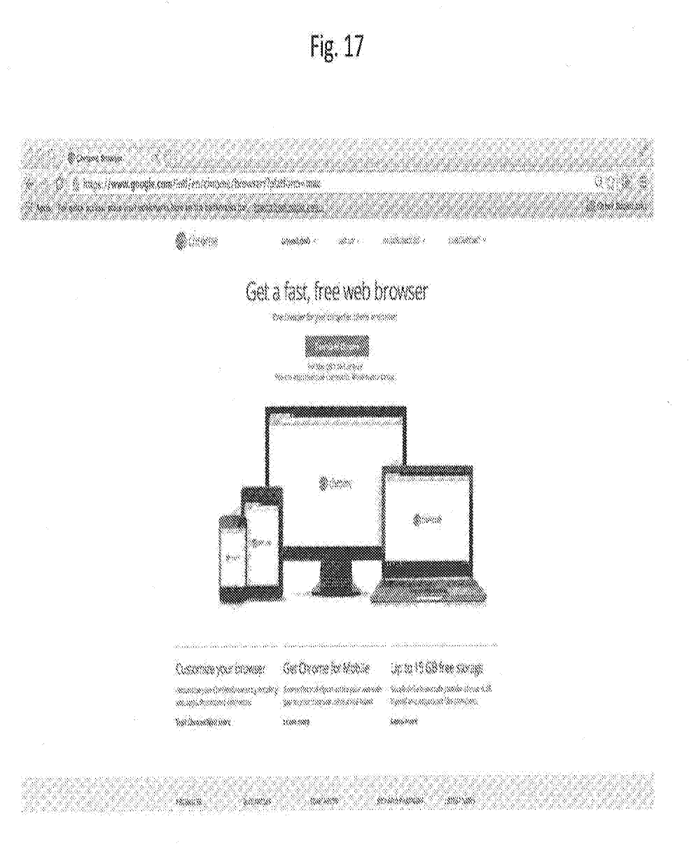

Once Step 4 has been completed, the voter file contains a certain number of voters that have been associated with a specific Facebook profile that is likely to belong to them. At this time a new batch of research queries may be created for research associates to look up and evaluate through use of the Extension. We call these queries “individual queries”, since they take the form of searches by name and location for specific individuals on Facebook. These queries can be approximated by typing “People named “[FIRST_NAME] [LAST_NAME]” who have ever lived near [CITY, STATE]” into the Graph Search toolbar. Like the “city searches”, these “individual searches” also follow a standardized format that can be seen in a URL: “http://www.facebook.com/search/str/FIRST_NAME%2520LAST_NAME/users-named/LOCATION_ID_NUMBER/residents/ever/intersect”. Take, for example, the search “People named “Matt Kalmans” who have ever lived near Philadelphia, Pa.”—the same results could be achieved by navigating directly to: named/101881036520836/residents/ever/intersect. The entries on the resulting page take the same form as those of “city searches” seen in FIG. 17. By batching and completing these searches, Applecart can comprehensively associate any publically viewable and searchable Facebook profiles with the voters targeted by the campaign in a Voter File. All individual searches may be performed by our research associates via the Applecart Social Research Google Chrome Extension described below.

Step 6—Collect Friends for Each Facebook Profile that has been Conclusively Associated with a Voter Through the Extension.

Once Steps 3, 4, and 5 have been completed, a final step in the exemplary process is to visit the friends page for each Facebook profile that has been conclusively associated with a voter (if it is publically viewable) and associate each of the voter's Facebook friends profiles that are listed with the voter in the voter file who is matched to that profile. Going back to Sacha Samotin's Facebook page, his friends page can be navigated to directly by entering the URL: http://www.facebook.com/samotin/friends. All profiles follow the same format: “http://www.facebook.com/VANITY_NAME/friends” or “http://www.facebook.com/USER_ID_NUMBER/friends”. When a research associate is assigned a friends collection task by the extension, they are directed to the friends page of a specific targeted profile and proceed to submit the URLs of each of the friends' profiles (which also follow the unique identifier [VANITY_NAME]/[USER_ID_NUMBER] format described above) to our servers for further analysis and manipulation.

At this phase, the work of the research assistants is largely complete, and the majority of the rest of the work may take place on system servers, using exemplary graph development algorithms, as described below in the Voter Graph Platform section. This work may take two forms—the first and most important is mapping and assigning weights to the connections between individuals (both online and inferred from offline information), and the second is finding other potential associations between Facebook profiles and voters in the voter file that were not discovered in the processing above (for example, because the person in question no longer lists their city of voter registration on their Facebook or has not enabled that privacy setting). In the second case, any new associations that are found are run themselves through step (6), if the associated profile belongs to a targeted voter.

Step 7—Understanding the Applecart Social Research Google Chrome Extension.

In one embodiment of the present invention, a process for executing all of the searches and data collection for a given political campaign may be assisted by entering the URLs that were created in (3), (5) and (6) into our Social Research Google Chrome Extension. The extension is software written in JavaScript for the purposes of assisting and aiding, the process of efficiently collecting social data for further use and analysis. Chrome is the web browser software provided for free by Google and it is available on Mac, Windows, and Linux operating systems. One of the many advantages to using Chrome as a web browser is that it makes “extensions”—small programs with a specific set of functionalities—easy to install and use. While some Chrome extensions are available to the public at large through the Google App Store, private-label extensions such as Applecart's are also easy to install. If one is running Windows, one will need to install the developer version of Google Chrome, Chrome Canary, for the purposes of using our extension. The Applecart Extension Installation and Use Instructions that we provide Research Associates are provided below under the heading “Web Research Instructions.” The Applecart extension has several functions that can be applied uniformly to different kinds of searches and data collection tasks, and is straightforward for end user. First, a Research Associate must log in to the extension with a provisioned username and password. Once logged into the extension and into Facebook, upon request, the extension will navigate the Research Associate to the URL of the next search query or data collection task—this is taken from a queue of search queries and data collection tasks that are stored and managed on our server infrastructure, a system that can handle an essentially limitless number of extensions-in-use at any one time. In the situation where the task contains data across multiple pages—a task that would require scrolling to the very bottom of the page in order to capture all of the available information—the Research Associate may use the extension to “Load Page”, maximizing the Research Associate's ability to attend to the more substantive research goals associated with this specific search or task, such as quality control. Once the page has finished loading and quality has been assured (for example, making sure that most of the results shown in a “city search” have that city listed in their profiles as they scroll by), the extension provides Research Associates with the functionality to submit the results of their search or their data collection task. At this point, the extension parses the HTML of the page to extract the relevant facts and data from the page, while ignoring all of the formatting code that is only relevant to Facebook's GUI. Once this process is complete, Research Associates can load a “New Person” or search. The extension provides Research Associates with a basic counter to keep track of their work progress, and system servers also track more comprehensive work progress statistics for administrator use.

While the process and Extension as described above specifically relate to Facebook, they are equally applicable to any similarly structured, similarly public social network, with minor modifications.

The following are detailed exemplary instructions for performing social connections research in exemplary embodiments of the present invention. The instructions are directed to researchers using exemplary embodiments of the present invention conducting social connections data collection, and thus speak to such researchers. The instructions contemplate using an Applecart developed extension to Google Chrome, but this is exemplary, and it is understood that similar functionality may be implemented in various programming languages and formats. While the example social medium used is that of Facebook, as noted, any social medium can be similarly mined for the social connections data.

Exemplary Web Research Instructions

Part One: Download and Installation Instructions

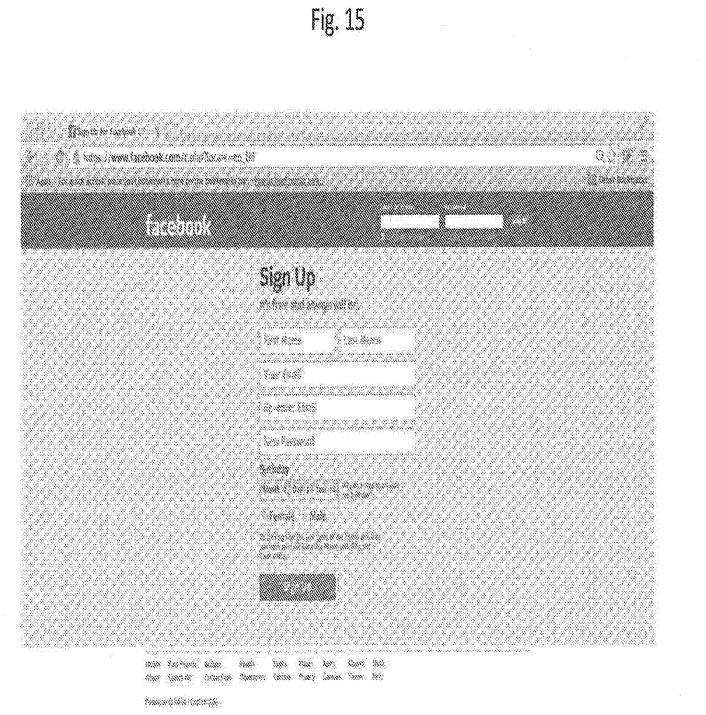

FIG. 15 illustrates Part One, Step One: Sign Up for a Facebook Account. Here a user may sign up for a Facebook account at https://www.facebook.com/r.php?locale=en_US, or if the user has an existing an Facebook account, they may log in to their account.

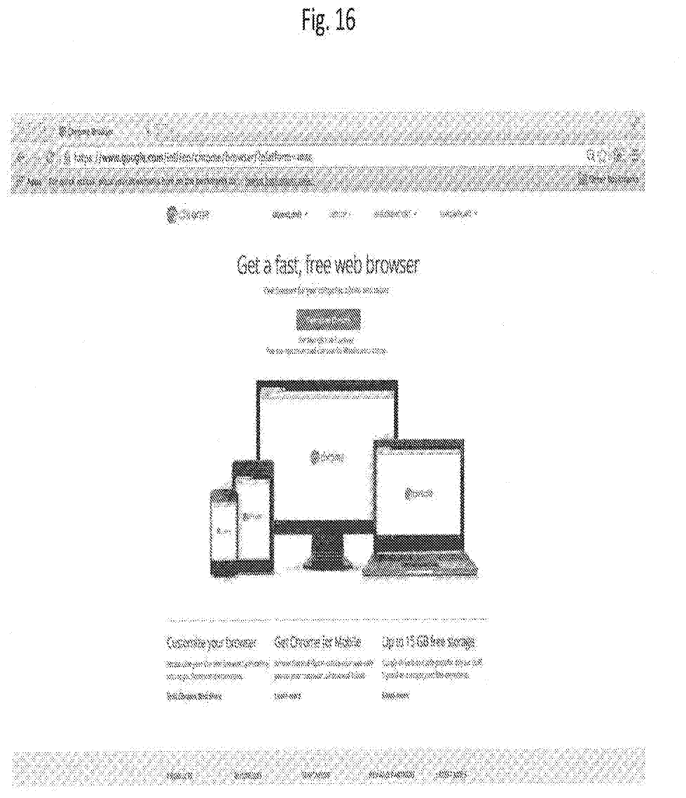

FIG. 16 illustrates Part One, Step Two: Download and Install Google Chrome (Windows) for Windows user, you must use Google Chrome Dev/Canary, download this even if you already have Google Chrome. Download Google Chrome Canary for Windows at http://www.google.com/intl/en/chrome/browser/canary.html.

FIG. 17 illustrates Part One, Step Two: Download and Install Google Chrome (Mac and Linux). Download Google Chrome for Mac OS X 10.6 or late at https://www.google.com/intl/en/chrome/browser/?platform=linux

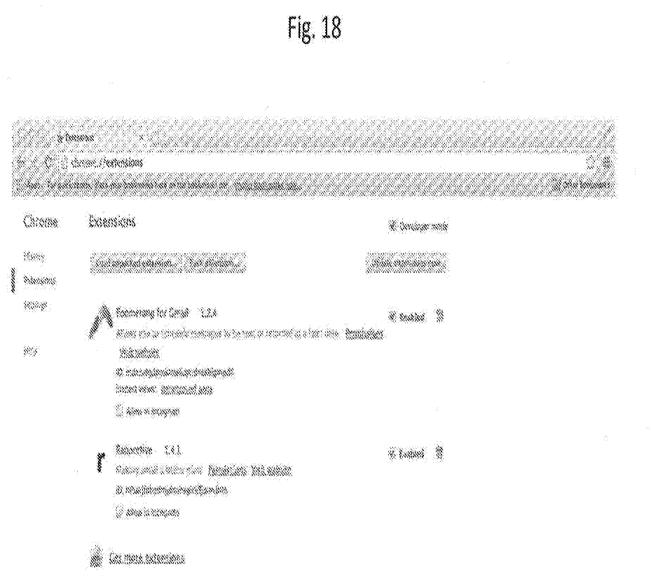

FIG. 18 illustrates Part One, Step Three: Download the Web Research Google Chrome Extension. Open Google Canary and visit. Find Applecart's web research Google Chrome Extension at https://s3.amazonaws.com/generic-collections-public/extension.crx. Download the Web Research Google Chrome Extension to your computer. Check the box that says “Developer Mode” in the upper right hand corner of the screen. Drag the downloaded file to the center of the Google Chrome Extension page to install.

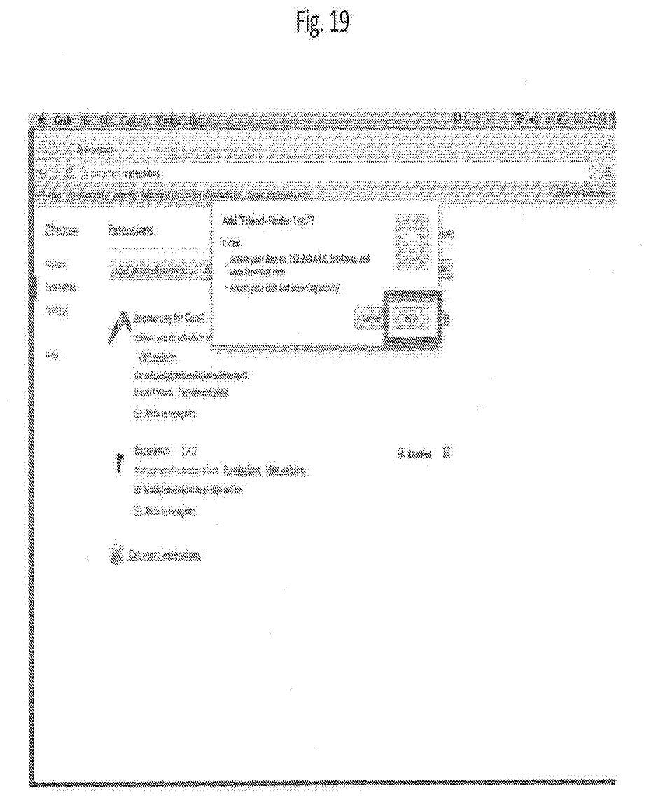

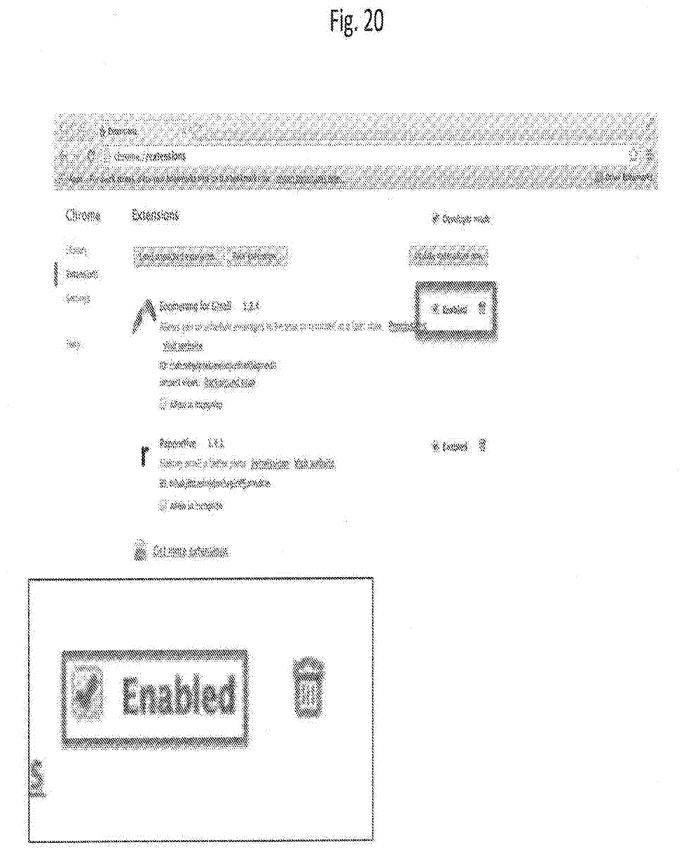

FIG. 19 illustrates Part One, Step Four: Install the Web Research Google Chrome Extension. Press the “Add” button in the popup window, and FIG. 20 illustrates Part One, Step Four: Install the Web Research Google Chrome Extension. Check the “enabled” box if it is not already checked.

Part Two: Web Research Tool Use Instructions

Part Two, Step One: Log in to Facebook. Part Two, Step Two: Close all other Google Chrome tabs and windows.

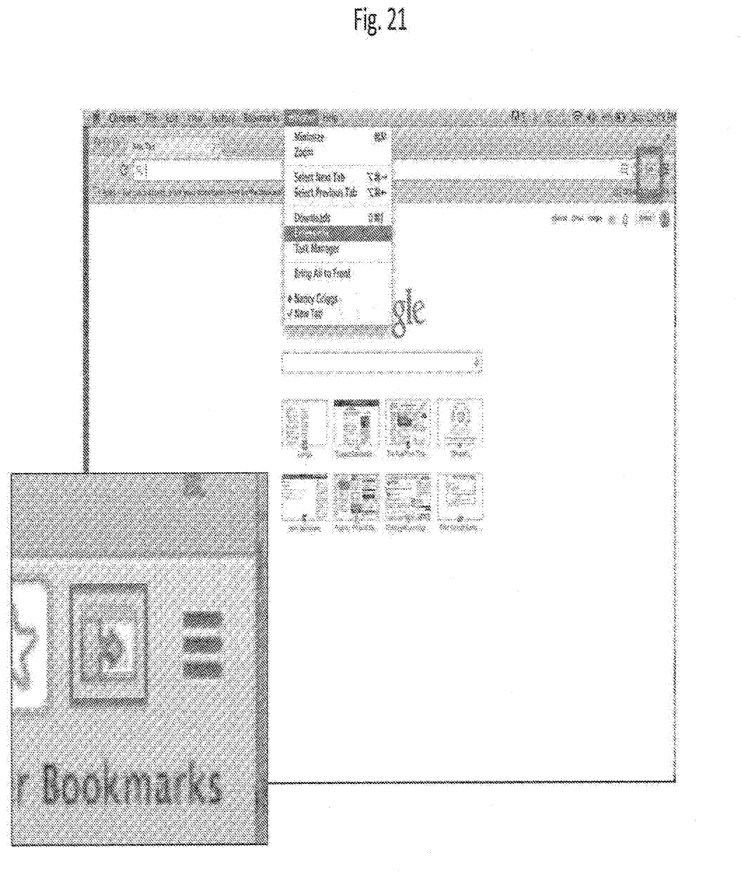

FIG. 21 illustrates Part Two, Step Three: Access Web Research Google Chrome Extension. Here a user should make sure they only have one Chrome Window and one Chrome tab open. They then press the extension button in the top right corner of the screen.

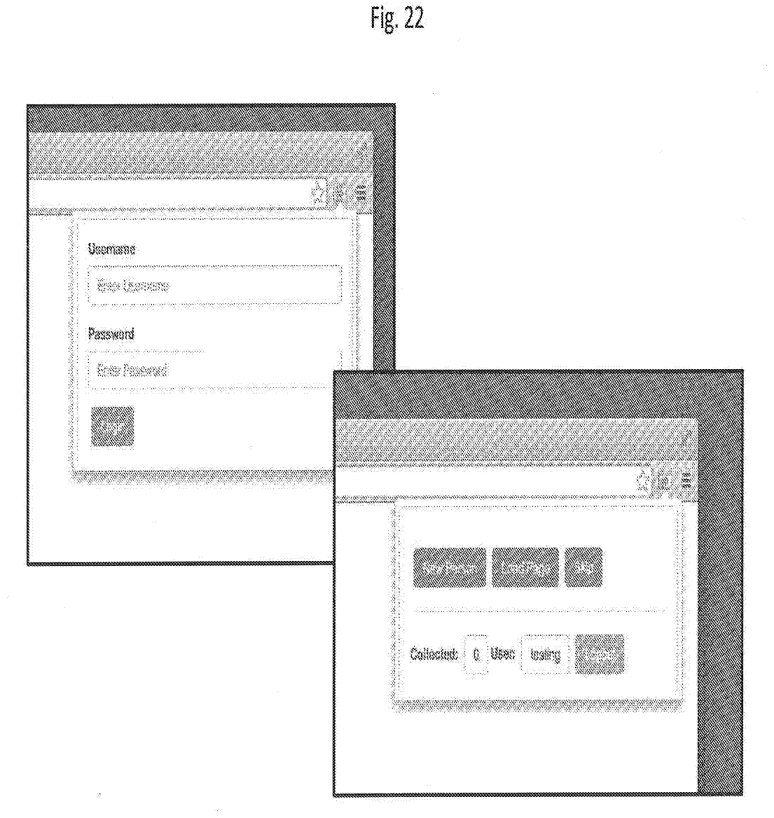

FIG. 22 illustrates Log-In Instructions for Google Chrome Extension. After pressing the extension button, the Chrome Extension box will drop down in the top right corner of the winder (shown in red). To Log In, a user:
enters the login credentials and press the green login button. If they are correct, the user is forwarded to the collections dashboard.
Here, there are the buttons for loading new “people” (e.g., voters) to process and some information about how many profiles have been successfully collected as well as a username.

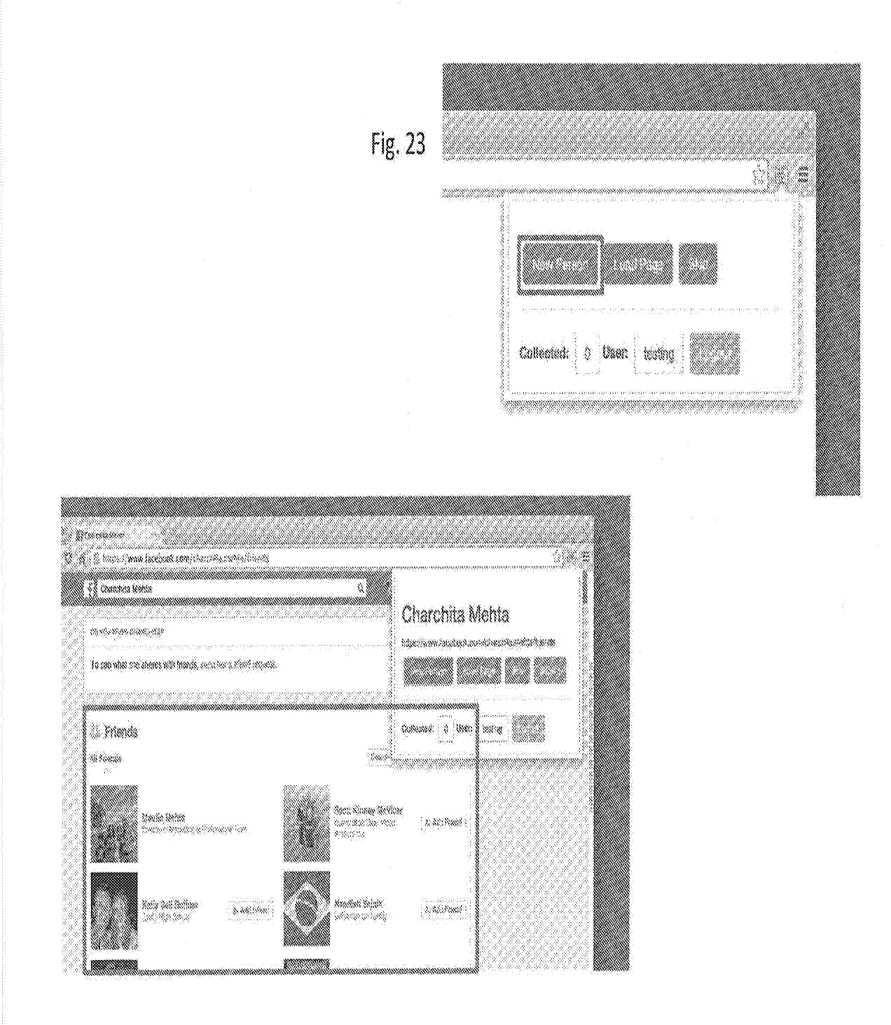

FIG. 23 illustrates Part Two, Step Four: Press the New Person Button. Here a user must make sure she only has one Chrome window and one Chrome tab open before beginning. Once logged in, the user should press the New Person button to load a new person. Once the person's Facebook profile is loaded, a list of friends should be seen.

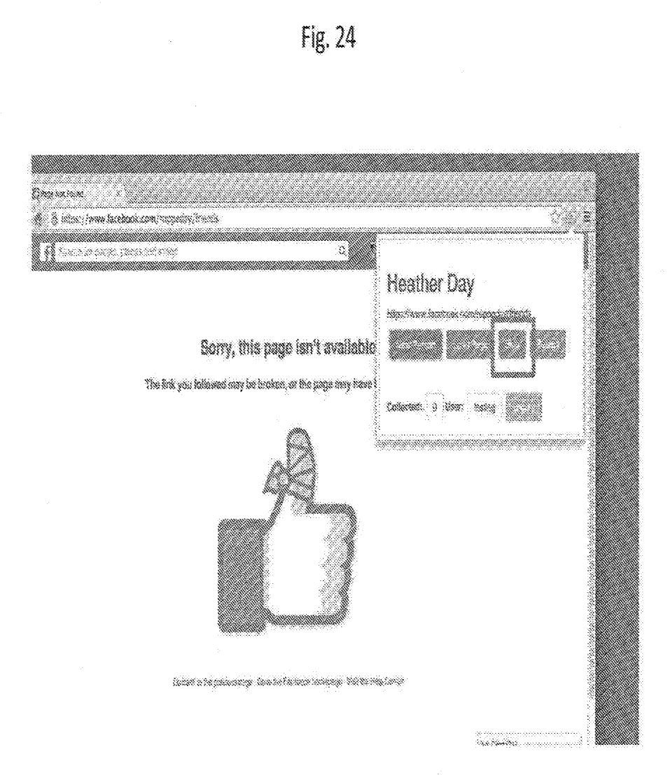

FIG. 24 illustrates Part Two, Step Four: Press the New Person Button. User should make sure she only has one Chrome window and one Chrome tab open before beginning. If the user receives an error message of some variety, he or she should hit SKIP (shown in Red).

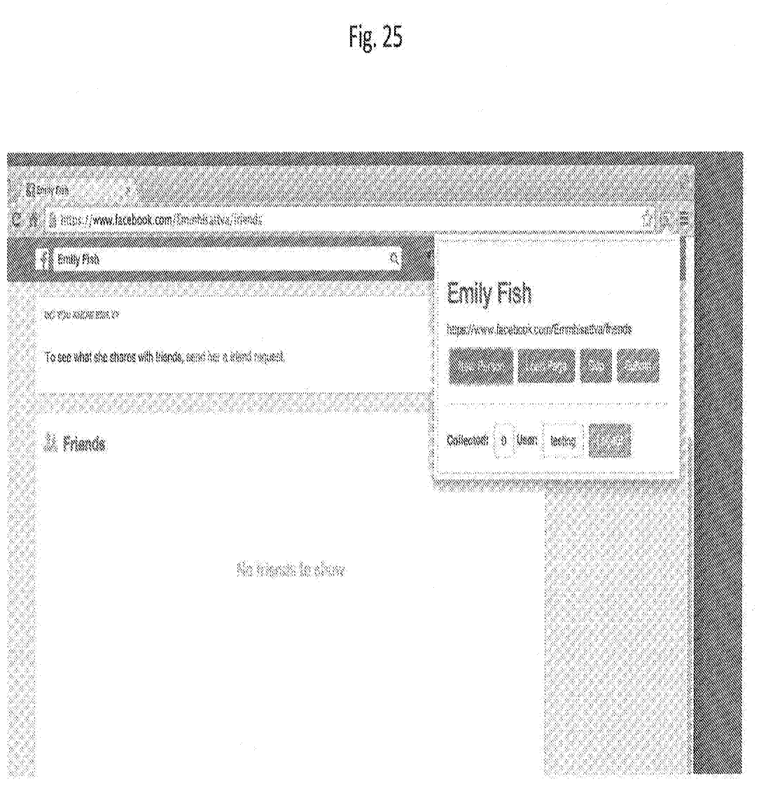

FIG. 25 illustrates Part Two, Step Four: No friends listed. Here, again, a user must make sure only one Chrome window and one Chrome tab are open before beginning. If there is no error message, but there are no friends listed, that is fine. Go on to the next step.

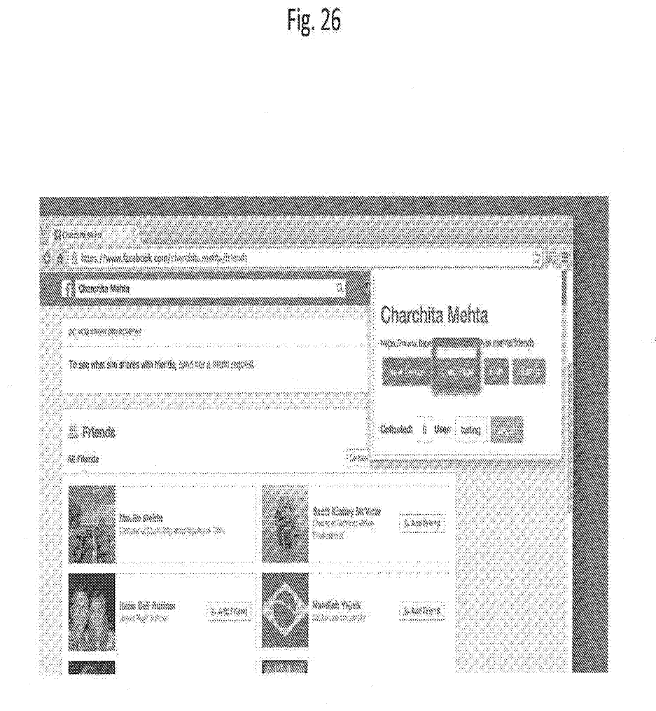

FIG. 26 illustrates Part Two, Step Five: Press the Load Page Button. Making sure only one Chrome window and one Chrome tab are open before beginning, as above, if you did not skip, and there are friends listed, proceed to press the Load Page Button (red box). Then WAIT until the page has finished scrolling to the bottom and loading. If there are no friends the software may not scroll down, and this ok. It may take from several seconds to a couple minutes for the page to fully load—depending on the number of friends the individual has. Here one MUST wait for the process to finish.

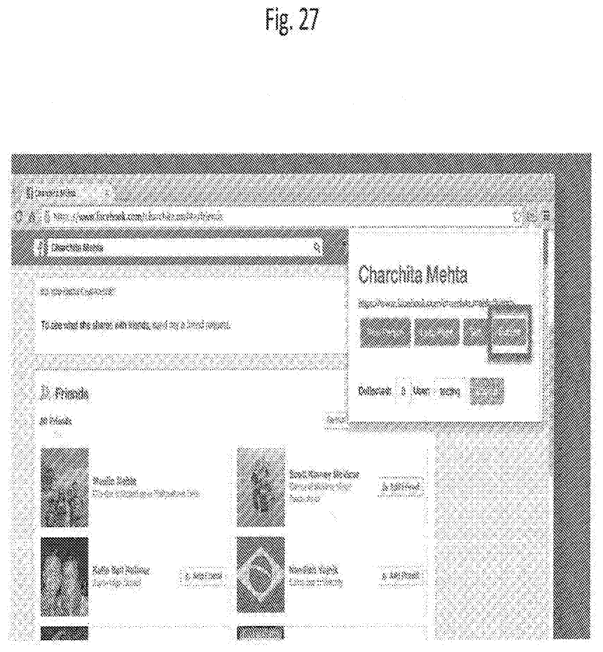

FIG. 27 illustrates Part Two, Step Six: Press the Submit button. Making sure only one Chrome window and one Chrome tab are open before beginning, as above, the user should wait until the page has finished scrolling to the bottom and loading, then press the submit button (BOXED IN RED).

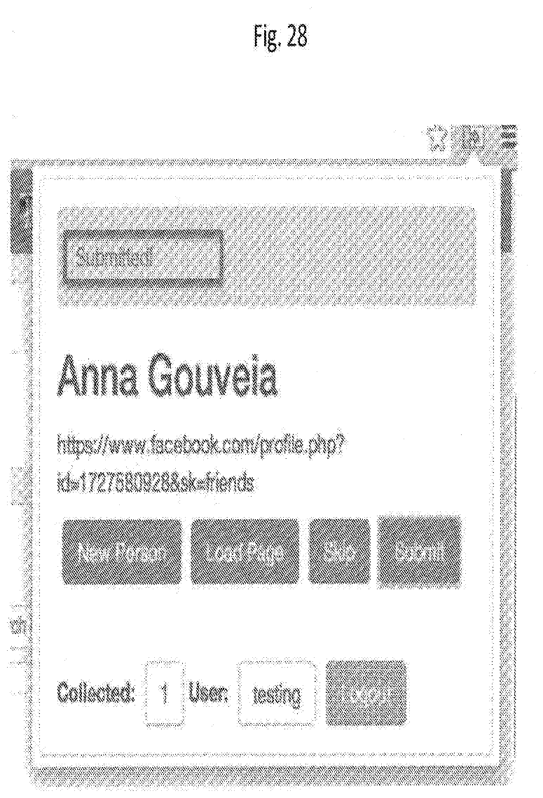

FIG. 28 illustrates Part Two, Step Six: Press the Submit Button. Making sure only one Chrome window and one Chrome tab are open before beginning, as above, a user should see a screen like this. Once “Submitted” is visible in green, the user has successfully submitted the information and the user's collected counter will increment.

At this point, a researching user should repeat Part Two, by repeating starting at Part Two, Step Four (as shown beginning with FIG. 23), to load as many new people as the researcher wishes to analyze in that session. Once the researcher has completed the desired amount of people and collected their data, he or she may move on to Part Three to logout.

Part Three: Web Research Tool Logout Instructions

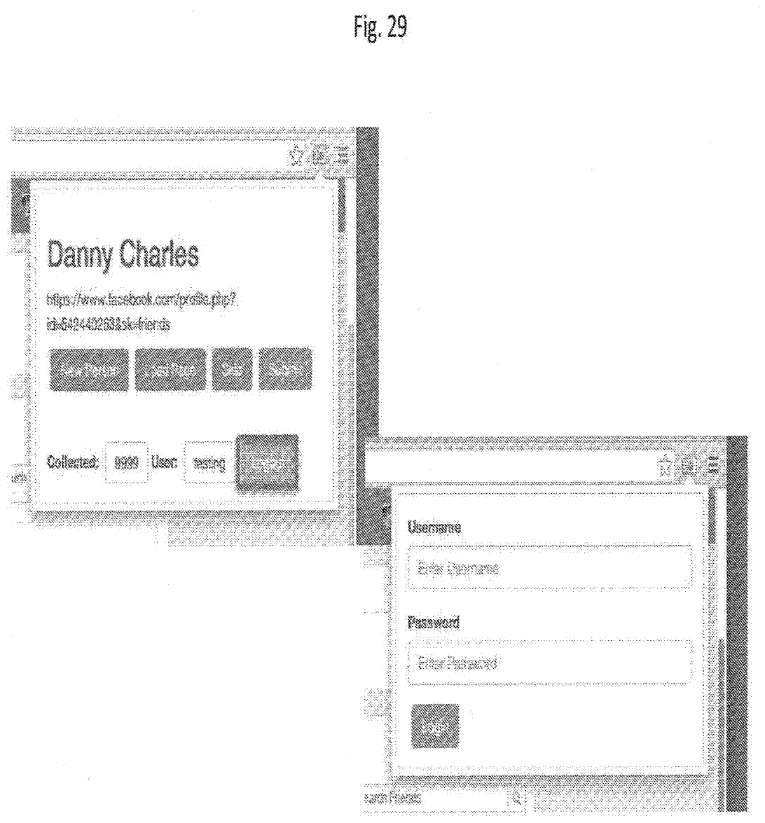

FIG. 29 illustrates Part Three, Step One: Log Out. Once a user has completed any given “collection session”, he or she should logout. This sends the number of collected profiles to a system server, and resets the researchers count. To do so, a user clicks Logout.

### Exemplary Implementations—General

Any suitable programming language may be used to implement the routines of particular embodiments including, but not limited to, the following: C, C++, Java, JavaScript, Python, Ruby, CoffeeScript, assembly language, Neo4j, etc. Different programming techniques may be employed such as procedural or object oriented. The routines may execute on a single processing device or multiple processors. Although the steps, operations, or computations may be presented in a specific order, this order may be changed in different particular embodiments. In some particular embodiments, multiple steps shown as sequential in this specification may be performed at the same time.

Particular embodiments may be implemented in a computer-readable storage device or non-transitory computer readable medium for use by or in connection with the instruction execution system, apparatus, system, or device. Particular embodiments may be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nano-engineered systems, components and mechanisms may be used. In general, the functions of particular embodiments may be achieved by any means as is known in the art. Distributed, networked systems, components, and/or circuits may be used. Communication, or transfer, of data may be wired, wireless, or by any other means. It will also be appreciated that one or more of the elements depicted in the drawings/figures may also be implemented in a more separated or integrated manner, or even removed or rendered as inoperable in certain cases, as is useful in accordance with a particular application. It is also within the spirit and scope to implement a program or code that may be stored in a machine-readable medium, such as a storage device, to permit a computer to perform any of the methods described above, or any portion thereof.

### Exemplary Implementations—Voter Graph Platform

In exemplary embodiments according to the present invention, a Voter Graph Platform (“VGP”) may be used. The VGP is designed to consume voter file, social media, and third-party demographic and behavior data and emit a ranked list of inter-voter connections as described above. The nature and weighting of this ranking are up to the user. The choice of ranking weights is as much of an art as it is a science and is determined depending on the specific use case to which the VGP is being applied. Take for example the exemplary embodiment discussed most frequently here: developing a list of the ten most relevant social influencers for a given target voter, in order to show their records to the target. In this case, we might prioritize a certain combination of voting histories over a specific degree of social interconnectedness; for example, choosing to show the target seven records that have a more frequent voter turnout history than the target, and three records with equally frequent or less frequent turnout histories, even if this would mean excluding several people who have better “social proximity” overall. Furthering the example, if target A is connected to 15 voters, numbered 1 to 15 respectively from most socially proximate to least socially proximate, we might prioritize showing the target the seven records with the lowest ranks that also have better voting records (here, 1, 10, 11, 12, 13, 14, 15) and the three records with the lowest ranks that also have equal or worse voting records (2, 3, 4). In this hypothetical, connected voters 5, 6, 7, 8, and 9 would be excluded from display not because of their degree of interconnectedness, which is actually superior to six of the records actually shown, but because of this additional input criterion. The chart in the section below “edge types” shows one such system of ranking that has been used in an exemplary embodiment of the invention. Other systems of ranking connections have been developed that use scaled weights (instead of fixed weights) and that prioritize factors such as a shared household or a “triadic” connection through a shared household member over some of the variables listed below, depending on the circumstances in which they were used.

For other exemplary embodiments of the VGP technology's ability to create a useful social graph, these ranking weights might be reweighted or reordered entirely based on the use case and the addition of additional data sources that aren't purely social in nature. In an exemplary embodiment of the VGP focused more on political campaign finance or nonprofit fundraising as opposed to simple voter mobilization, the additional data source of a connection's previous donation history in terms of volume of donations, frequency of donations, and ideology of the candidate receiving the donation would factor significantly into the ranking ultimately displayed to the target or used for further outreach. In an exemplary embodiment of the VGP focused more on political persuasion as opposed to simple voter mobilization, the specific modeled ideology—or even actual documented poll-based or in-person interactions with the targeted voter and the connected voter would factor significantly into the ranking. In another similar exemplary embodiment, the rankings might be reweighted and reordered more to measure the centrality of the target within the graph as a whole, as opposed to simply finding the “spokes” that extend from the targeted voter “node”.

The following are the general system requirements for the current version of the Voter Graph Platform that we have used in our most recent deployments of the Applecart technology. These requirements may change depending on the size and scope of the particular Voter Graph Platform that is needed for a given deployment.

The following description makes reference to exemplary scripts and associated algorithms necessary to operate an exemplary embodiment of a Voter Graph Platform to construct individualized social graph treatments for each target voter according to an exemplary embodiment of the present invention. It further makes reference to an exemplary representation of the package of scripts necessary to associate collected social network data with individuals in the voter file and output individualized treatments for targeted voters. Both of these sets of exemplary scripts are provided at the end of this section.

Requirements

In an exemplary embodiment, running VGP requires at least the following:

Python 2.7 (Standard Library, Pymongo)

MongoDB (2.6 or better)

RAM>=32 GB (as much as possible)

4+ CPU cores

100 GB+hard drive space (preferably SSD in the 300 GB range)

Basics

The workflow for VGP has three parts:
Preprocessing (moving the data from MySQL remote stores, setting up the data in the MongoDB database, and initializing and prepopulating the social graph);
Mapping (enriching the graph with physical and demographic data, and with results of similarity algorithms); and
Postprocessing (essentially using MapReduce to combine the edge weights and emitting a rank list of voter connections).

Operation

There are three exemplary scripts that may be used perform the steps described above. They may be provided in an exemplary python/runtime directory in a given implementation, and they are provided below. They must be run in the following sequence:

PreProcess.py (see PreProcess Script provided below)

Runner.py (see Runner Script provided below)

PostProcess.py (see PostProcess Script provided below)

Each script takes some time to run and the runtime may vary based upon the size of the input data. It is critically important that the available RAM be sufficient on the machine to prevent disk thrashing. Thrashing destroys performance. During the running time for each of three processes, ample notices are printed to the screen during most of the work (exception is the PostProcess MapReduce phase). Because execution time can be measured in hours, in exemplary embodiments of the present invention, one should use a ‘screen’ job to run them, especially if using a remote server.

The final output to CSV may be most reliably accomplished, for example, via the mongoexport program that comes with MongoDB. An example for this is provided in the PreProcess.py script.

Edge Types

The following are the tags assigned to the edges between voters in the voter graph:

| Name | Weight | Description |
|---|---|---|
| fb_friends_known | 256 | Assigned with direct inclusion of sink in |
| | | source's friend list |
| fb_friends_implied | 128 | Assigned as implicit friend connection for sink |
| | | when source includes sink |
| fb_friends_inferred_strong | 64 | Assigned when two nodes have friend |
| | | networks with high degree of similarity |
| cross-triadic | 64 | Assigned between A and C where A and B are |
| | | strongly connected on a social network and B is |
| | | connected C, which is not on the social |
| fb_friends_inferred_weak | 32 | Assigned when two nodes have friend |
| | | networks with low degree of structural |
| hh | 32 | Assigned when two nodes share a household |
| local_and_similar | 16 | Assigned when two nodes have similar |
| | | demographics above threshold and live in the |
| | | same geobucket |
| same_block | 8 | Assigned when two nodes reside on the same |
| | | block or apartment building |

These weights are editable in the mapreduce/scripts/tabulate_weights_mapper.js file, as shown, for example, in exemplary Tabulate Weights Script provided below. They can, and almost certainly will, be adjusted in various exemplary embodiments of the present invention, as the weights may be more intuitive than scientific. Structural similarity was used to resolve the distinctions in the inferred tags.

Output

The output CSV file describes the directed edges between voters. In this iteration, the edges are often symmetric, but not always. Each line of the output takes the following form.

<source_id>,<sink_id>,weight

Where source_id and sink_id are the voter's api_id value, and weight is the sum of the edge weights between the source and the sink.

This format can be easily imported into a SQL table and joined with other tables.

Additional Features

Additional versions of the VGP to provide a fuller exploitation of the data involve making the following adjustments:
Restructure the MapReduce operation to deal with inverting connections and thus provide intelligent adaption across mixes of edge attributes doing the postprocessing phase. I experimented some with this, but abandoned because of lack of time.
Add an ‘entity’ node concept that would gather common non—person connections (i.e., an employer, association, magazine subscription) and then assign that connection type to all the connected nodes. (There is insufficient data to carry this out now.)
Additional MapReduce jobs can operate on connection_edges to determine node centrality measures, clustering coefficients, and so on.
The connection_edges data can further be used to create the vectorization of cases (voters and their relationships to other voters) that would enable prediction or inferences of voter propensities.

Exemplary Case Studies

The following two actual case studies illustrate actual use of an exemplary embodiment of the present invention, and the results obtained. To put it mildly, the applecart was, in fact, upset.

A. Demonstrating the Efficacy of the Applecart Approach

To scientifically prove Applecart's dramatic improvement over conventional and thus more well-established social pressure “get out the vote” tactics, Project Applecart partnered with a major national political group affiliated with one of the two major parties in the spring of 2014 to implement Applecart's approach alongside the conventional social pressure alternative in a randomized controlled experiment. Applecart chose a congressional district's May 2014 primary in a Midwestern as the site for the experiment. This congressional district was chosen because there were no competitive races on the ballot, it was the most rural district in the state, and there was a stringent voter ID law that was recently passed, all factors that should have provided for the most depressed turnout imaginable. If we could significantly increase turnout in this environment, we felt confident that Applecart would be even more effective in the significantly more favorable turnout environment of a typical low-turnout election. Our experiment was composed of three experimental groups: the first group had a sample size of 14,525 households and received no voter contact, the second group had a sample size of 5,667 household and received the conventional social pressure turnout treatment that consists of sending a target voter their neighbors' voting records via mail, and the final group with a sample size of 14,298 households received the Applecart program that sent target voters their social influencers' voting records (as determined by our proprietary graph technology) via direct mail, cookie-matched online ads, and a targeted email campaign. Therefore, the test had a 99% confidence interval and 0.76% margin of error, and all groups were randomized across all relevant variables (age, gender, county of residence, vote history, household etc.) per a chi-square test. To put this in both a political and apolitical context: the average high quality poll conducted for a statewide election usually has between 700 and 1000 respondents, a margin of error between 3% and 5%, and is only conducted to a 95% confidence level. In an apolitical context, a randomized and controlled drug trial usually is often conducted to only a 90% or 95% confidence level-meaning that the results seen would be expected to fall outside of the stated margin of error in 1 in 10 or 1 in 20 trials conducted under identical conditions (as opposed to 1 in 100 and a much smaller margin of error in Applecart's Arkansas test).

After the election, upon analyzing the subjects' individual voting records to determine who responded to our contact, the control group voted at 17.2%, the neighbors group voted at 19.7%, and the Applecart group voted at nearly double the increased rate of 21.7%. When comparing our experimental groups to those of the original experimental research that proved the efficacy of the neighbors approach-which was conducted in a competitive primary election-we found that when analyzing the subsets of each of our experimental groups that overlapped, we would have seen the Applecart approach produce a 14.6% turnout increase over the control group in a competitive primary, to the neighbors approach's 8.1%, as established by the original study.

Our experiment proved that the turnout increase produced by the Applecart approach significantly exceeded to the point of nearly doubling that produced by the neighbors contact across all vote history segments, genders, and age. The results of this experiment suggest that Applecart is the single most effective intervention that can be used to significantly boost turnout in an American election.

B. Applecart Wins in 2014

In the 2014 midterms, Applecart mobilized voters in four highly competitive statewide races: the gubernatorial races in a Midwestern and northeastern state and the senatorial races in a Western and Midwestern state. All four candidates that Applecart was hired to support won their races, while two of the candidates were widely expected to be defeated by significant margins. The day before the November 4 election the National Review reported that a large national partisan political organization had thrown in the towel on the Midwestern gubernatorial race. The following evening, the candidate that Applecart supported in that race defeated his opponent by 3.9%. Meanwhile in the northeastern state, the candidate we supported won a shocking victory over his opponent; an upset largely attributed by Politico to “surprisingly strong rural turnout.” Qualitative and quantitative factors both point to Applecart as the marquee factor in both victories. In fact, two of the races were all decided by smaller margins than the number of additional votes that Applecart promised to mobilize on behalf of their clients in each race.

| | | | Nate Silver's | |
|---|---|---|---|---|
| | | | Predicted Margin | Actual Margin |
| | | Applecart's | of Victory for | of Victory for |
| | | Promised | Applecart's | Applecart's |
| | Targeted | Mobilization | Preferred | Preferred |
| Race | Voters | Add (Voters) | Candidate | Candidate |
| Midwestern | 287,729 | 49,542 | −19,504 | 33,052 |
| Gubernatorial | | | | |
| Race | | | | |
| Northeastern | 105,586 | 19,322 | −3,026 | 29,727 |
| Gubernatorial | | | | |
| Race | | | | |
| Western | 52,666 | 10,278 | 4,502 | 6,053 |
| Senatorial Race | | | | |

Methods of the present invention may be adapted for mobilizing targeted individuals to take additional actions in a political context, such as donating, registering to vote, and supporting a specific candidate, and in a private sector context, such as purchasing a product or taking action to advocate for a specific targeted policy issue. The only difference between these additional methods and the one most prominently described here (infrequent voter mobilization) are the questions of who is targeted and what additional data is overlaid on the construction of the “social graph” used in the individual message. By overlaying campaign donation data, one embodiment of the invention would allow the individual message to be tailored to the targeted voter's history of and potential for political donation to a specific candidate along a specified ideological line. By overlaying issue and interest data, one embodiment of the invention would allow the individual message to be tailored to persuading the targeted voter to assess or reassess a political or ideological position. By laying eligible but currently unregistered voters into the social graph, one embodiment of the invention would allow the individual message to be tailored to convince that eligible registrant to actually take the action of registering. The fundamental approaches, technologies, and invention do not have to be substantially altered to achieve any one of these goals and any one of a whole host of other political, issue-based advocacy, non-profit, and consumer marketing paradigms. For other exemplary embodiments of the VGP technology's ability to create a useful social graph, these ranking weights might be reweighted or reordered entirely based on the use case and the addition of additional data sources that aren't purely social in nature. In an exemplary embodiment of the VGP focused more on political campaign finance or nonprofit fundraising as opposed to simple voter mobilization, the additional data source of a connection's previous donation history in terms of volume of donations, frequency of donations, and ideology of the candidate receiving the donation would factor significantly into the ranking ultimately displayed to the target or used for further outreach. In an exemplary embodiment of the VGP focused more on political persuasion as opposed to simple voter mobilization, the specific modeled ideology—or even actual documented poll-based or in-person interactions with the targeted voter and the connected voter would factor significantly into the ranking. In another similar exemplary embodiment, the rankings might be reweighted and reordered more to measure the centrality of the target within the graph as a whole, as opposed to simply finding the “spokes” that extend from the targeted voter “node”. While there have been described various exemplary methods for voter analysis, processing and targeted messaging, it is to be understood that many changes may be made therein without departing from the spirit and scope of the invention. Insubstantial changes from the claimed subject matter as viewed by a person with ordinary skill in the art, no known or later devised, are expressly contemplated as being equivalently within the scope of the claims. Therefore, obvious substitutions now or later known to one with ordinary skill in the art are defined to be within the scope of the defined elements. The described embodiments of the invention are presented for the purpose of illustration and not of limitation. It should be understood and appreciated by those skilled in the art that the systems and methods described herein, while explained in the context of federal elections and congressional districts, apply equally to state, city, county and local elections which similarly use voting districts that may be designed to emphasize or incorporate particular characteristics of the voting population.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

1-26. (canceled)

27. A method for improved communications with a plurality of voters in a voting district, comprising:
aggregating, using a data processor, information on registered voters of the plurality of voters, wherein the aggregated information is indicative of past voting history;
supplementing, using a data processor, the aggregated information with social graph data comprising a respective weight assigned to each of the voters, wherein the respective weight is indicative of a degree of connectedness between the plurality of voters based on online data sources and offline data sources;
developing, using a data processor, a targeting model for unregistered voters of the plurality of voters based on the respective weight;
selecting, using a data processor, a plurality of better voters who are connected to a select member of the unregistered voters based on the targeting model and with better voting histories than the select member along with a plurality of worse voters who are connected to the select member and with worse voting histories than the select member; and
generating, using a data processor, a targeted message for the select member, the targeted message including the selected better voters and the selected worse voters.

28. The method of claim 27, wherein:
the voting district is one or more of (i) a congressional district, (ii) a state voting district, (iii) a county voting district, (iv) a city voting district, and (v) a local government voting district; and
the plurality of voters is associated with one or more of a specific ideological concern, issue orientation, degree of moderateness or extremism, and party affiliation.

29. The method of claim 27, wherein the aggregated information includes identity information for registered voters in the voting district and voting record information for the registered voters.

30. The method of claim 29, wherein the degree of connectedness between the registered voters and the remaining unregistered voters is further based on:
extracting information indicative of real-world connections between voters of the plurality of voters based on an online social networking site or modeling and mining processes that are applied to all manner of unstructured data that can be found both on the Internet and in the physical world, information obtained by social connection vendors or intelligent search and collection procedures, information obtained from web crawlers to be used on irregular web data such as news sources and newspaper archives,
information obtained via in person research on irregular physical data sources such as high school yearbook collections, and
information as modeled through various algorithmic approaches.

31. The method of claim 30, wherein the online social networking site includes one or more public social networks, such as Facebook and LinkedIn.

32. The method of claim 27, wherein:
the delivering includes via one or more of e-mail, direct mail, online application, social network advertisement and mobile device delivery, and wherein
the respective message includes voting records of one or more of: the select member's (a) close friends, (b) colleagues, (c) family members, and (d) a list of relevant social influencers associated with a perfect voting record, in relation to the select member's voting record.

33. A non-transitory computer readable medium containing instructions that, when executed by at least one processor of a computing device, cause the computing device to:
aggregate information on registered voters of the plurality of voters, wherein the aggregated information is indicative of past voting history;
supplement the aggregated information with social graph data comprising a respective weight assigned to each of the voters, wherein the respective weight is indicative of a degree of connectedness between the plurality of voters based on online data sources and offline data sources;
develop a targeting model for unregistered voters of the plurality of voters based on the respective weight;
select a plurality of better voters who are connected to a select member of the unregistered voters based on the targeting model and with better voting histories than the select member along with a plurality of worse voters who are connected to the select member and with worse voting histories than the select member; and
generate a targeted message for the select member, the targeted message including the selected better voters and the selected worse voters.

34. The non-transitory computer readable medium of claim 33, wherein the plurality of voters includes one or more of:
potential donors to a charity,
employees of a company or commercial concern, and
members of a club, association or affinity group.

35. A system for improved communications with a plurality of voters in a voting district, comprising:
at least one processor;
one or more displays; and
memory containing instructions that, when executed, cause the at least one processor to:
aggregate information on registered voters of the plurality of voters, wherein the aggregated information is indicative of past voting history;
supplement the aggregated information with social graph data comprising a respective weight assigned to each of the voters, wherein the respective weight is indicative of a degree of connectedness between the plurality of voters based on online data sources and offline data sources;
develop a targeting model for unregistered voters of the plurality of voters based on the respective weight;
select a plurality of better voters who are connected to a select member of the unregistered voters based on the targeting model and with better voting histories than the select member along with a plurality of worse voters who are connected to the select member and with worse voting histories than the select member; and
generate a targeted message for the select member, the targeted message including the selected better voters and the selected worse voters.

36. The system of claim 35, wherein:
the voting district is one or more of (i) a congressional district, (ii) a state voting district, (iii) a county voting district, (iv) a city voting district, and (v) a local government voting district; and
the plurality of voters is associated with one or more of a specific ideological concern, issue orientation, degree of moderateness or extremism, and party affiliation.

37. The system of claim 35, wherein the delivering includes via one or more of e-mail, direct mail, online application, social network advertisement and mobile device delivery.

38. The system of claim 35, wherein the aggregated information includes identity information for registered voters in the voting district and voting record information for the registered voters.

39. The system of claim 38, wherein the online data sources and the offline data sources include social connection data that includes one or more of:
information from an online social networking site,
information on real-world connections between individuals based on their social network connections or modeling and mining processes that are applied to all manner of unstructured data that can be found both on the Internet and in the physical world, information obtained by social connection vendors or intelligent search and collection procedures, information obtained from web crawlers to be used on irregular web data such as news sources and newspaper archives,
information obtained via in person research on irregular physical data sources such as high school yearbook collections, and
information as modeled through various algorithmic approaches.

40. The system of claim 39, wherein the online social networking site includes one or more public social networks, such as Facebook and LinkedIn.

41. The system of claim 35, wherein the respective message includes voting records of one or more of: the select member's (i) close friends, (ii) colleagues, (iii) family members, and (iv) a list of relevant social influencers associated with a perfect voting record, in relation to the select member's voting record.
